(19) United States
(12) Patent Application Publication
(10) Pub. No.: US 2014/0089420 A1
(43) Pub. Date: Mar. 27, 2014

(54) Methods, Systems, and Program Products for Processing a Reference in a Communication to a Remote Data Object

(71) Applicant: DEEP RIVER VENTURES, LLC, Raleigh, NC (US)

(72) Inventor: Robert Paul Morris, Raleigh, NC (US)

(73) Assignee: DEEP RIVER VENTURES, LLC, Raleigh, NC (US)

(21) Appl. No.: 13/624,940

(22) Filed: Sep. 23, 2012

(51) Int. Cl. G06F 15/16

(52) U.S. Cl. 709/206

(57) ABSTRACT

Descriptions are provided for processing a reference in a communication to a remote data object. In an aspect, information is received, by a second communications agent, that identifies a data object in a second data store in a second execution environment that includes the second communications agent. A descriptor is created for accessing the data object. The descriptor is sent in a first message, by the second communications agent, that is received by a first communications agent in a first execution environment, via a communications protocol. The data object is not included in the first message. A second message that identifies the data object is sent from the first communications agent to the second communications agent, via the communications protocol. Some or all of the data object is sent, via the network, by the second execution environment and received by the first execution environment.

### RELATED APPLICATIONS

This application is related to the following pending U.S. patent applications that are not commonly owned but by the same inventor: application Ser. No. 12/833,016 (Docket No 0158) filed on Jul. 9, 2010, entitled “Methods, Systems, and Program Products for Referencing an Attachment in a Communication”; and

application Ser. No. 12/833,014 (Docket No 0155) filed on Jul. 9, 2010, entitled “Methods, Systems, and Program Products for Processing a Request for a Resource in a Communication”.

This application is related to the following commonly owned, pending U.S. patent application: application Ser. No. 13/624,906 (Docket No DRV0001) filed on Sep. 22, 2012, entitled “Methods, Systems, and Program Products for Processing a Data Object Identification Request in a Communication”.

### BACKGROUND

While receiving attachments in network communication, such as email, is common, most attachments received are unsolicited or unrequested. Some attachments are quite large and consume user time in waiting for them to be downloaded. Some attachments are unloaded. In some circumstances it might be helpful for a user to know what data is available that can be received as an attachment. This would allow a user to request the data desired and avoid receiving unwanted attachments.

Accordingly, there exists a need for methods, systems, and computer program products for processing a reference in a communication to a remote data object.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Methods and systems are described for processing a reference in a communication to a remote data object. In one aspect, the method includes receiving, via a first communications protocol via a network from a second execution environment, a first message, by a first communications agent in a first execution environment, that includes a data object descriptor that identifies a data object in a data store in the second execution environment, wherein the first message is addressed to a first user represented by the first communication agent. The method further includes sending, via the first communications protocol via the network by the first communications agent, a second message addressed to a second user represented by a second communications agent in the second execution environment, that identifies, based on the data object descriptor, the data object. The method still further includes receiving, via the network by the first execution environment, at least a portion of the data object in response to sending the second message. Performing at least one the preceding actions comprising the method includes execution of an instruction by a processor.

Also, a system for processing a reference in a communication to a remote data object is described that includes one or more processors and logic encoded in one or more tangible media for execution by the one or more processors that when executed is operable for receiving, via a first communications protocol via a network from a second execution environment, a first message, by a first communications agent in a first execution environment, that includes a data object descriptor that identifies a data object in a data store in the second execution environment, wherein the first message is addressed to a first user represented by the first communication agent; sending, via the first communications protocol via the network by the first communications agent, a second message addressed to a second user represented by a second communications agent in the second execution environment, that identifies, based on the data object descriptor, the data object; and receiving, via the network by the first execution environment, at least a portion of the data object in response to sending the second message.

Further, a system for processing a reference in a communication to a remote data object is described. The system includes a content manager component for receiving, via a first communications protocol via a network from a second execution environment, a first message, by a first communications agent in a first execution environment, that includes a data object descriptor that identifies a data object in a data store in the second execution environment, wherein the first message is addressed to a first user represented by the first communication agent. The system further includes an access request constructor component for sending, via the first communications protocol via the network by the first communications agent, a second message addressed to a second user represented by a second communications agent in the second execution environment, that identifies, based on the data object descriptor, the data object. The system still further includes a data object handler component for receiving, via the network by the first execution environment, at least a portion of the data object in response to sending the second message. The system also includes a processor, wherein at least one of the content manager component, the access request constructor component, and the data object handler component include an instruction that is executed by the processor during operation of the system.

Methods and systems are described for processing a reference in a communication to a remote data object. In one aspect, the method includes receiving, by a second communications agent that represents a second user, data object information that identifies a data object in a second data store in a second execution environment that includes the second communications agent. The method further includes creating a data object descriptor for accessing the data object from the second data store by a first execution environment including a first communications agent that represents a first user. The method still further includes sending, via a communications protocol via the network by the second communications agent, a first message, addressed to the first user, including the data object descriptor, wherein the data object is not included in the first message. The method additionally includes receiving, via the first communications protocol via the network from the first communications agent, a second message addressed to the second user, that identifies, based on the data object descriptor, the data object. The method also includes sending, via the network by the second execution environment, at least a portion of the data object in response to receiving the second message. Performing at least one the preceding actions comprising the method includes execution of an instruction by a processor.

Also, a system for processing a reference in a communication to a remote data object is described that includes one or more processors and logic encoded in one or more tangible media for execution by the one or more processors that when executed is operable for receiving, by a second communications agent that represents a second user, data object information that identifies a data object in a second data store in a second execution environment that includes the second communications agent; creating a data object descriptor for accessing the data object from the second data store by a first execution environment including a first communications agent that represents a first user; sending, via a communications protocol via the network by the second communications agent, a first message, addressed to the first user, including the data object descriptor, wherein the data object is not included in the first message; receiving, via the first communications protocol via the network from the first communications agent, a second message addressed to the second user, that identifies, based on the data object descriptor, the data object; and sending, via the network by the second execution environment, at least a portion of the data object in response to receiving the second message.

Further, a system for processing a reference in a communication to a remote data object is described. The system includes a data object handler component for receiving, by a second communications agent that represents a second user, data object information that identifies a data object in a second data store in a second execution environment that includes the second communications agent. The system further includes a descriptor generator component for creating a data object descriptor for accessing the data object from the second data store by a first execution environment including a first communications agent that represents a first user. The system still further includes a remote access handler component for sending, via a communications protocol via the network by the second communications agent, a first message, addressed to the first user, including the data object descriptor, wherein the data object is not included in the first message. The system additionally includes a data object request component for, receiving, via the first communications protocol via the network from the first communications agent, a second message addressed to the second user, that identifies, based on the data object descriptor, the data object. The system also includes a data object response component for, sending, via the network by the second execution environment, at least a portion of the data object in response to receiving the second message. The system also includes a processor, wherein at least one of the data object handler component, the descriptor generator component, the remote access handler component, the data object request component, and the data object response component includes an instruction that is executed by the processor during operation of the system.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a block diagram illustrating an exemplary hardware device included in and/or otherwise providing an execution environment in which the subject matter may be implemented;

FIG. 2A is a flow diagram illustrating a method for processing a reference in a communication to a remote data object according to an aspect of the subject matter described herein;

FIG. 2B is a flow diagram illustrating a method for processing a reference in a communication to a remote data object according to an aspect of the subject matter described herein;

FIG. 3A is a block diagram illustrating an arrangement of components for processing a reference in a communication to a remote data object according to another aspect of the subject matter described herein;

FIG. 3B is a block diagram illustrating an arrangement of components for processing a reference in a communication to a remote data object according to another aspect of the subject matter described herein;

FIG. 4 is a block diagram illustrating an arrangement of components for processing a reference in a communication to a remote data object according to another aspect of the subject matter described herein;

FIG. 5 is a network diagram illustrating a system for processing a reference in a communication to a remote data object according to another aspect of the subject matter described herein;

FIG. 6A is a diagram illustrating a user interface presented via a display according to another aspect of the subject matter described herein;

FIG. 6B is a diagram illustrating a user interface presented via a display according to another aspect of the subject matter described herein;

FIG. 6C is a diagram illustrating a user interface presented via a display according to another aspect of the subject matter described herein;

FIG. 6D is a diagram illustrating a user interface presented via a display according to another aspect of the subject matter described herein;

FIG. 6E is a diagram illustrating a user interface presented via a display according to another aspect of the subject matter described herein;

FIG. 6F is a diagram illustrating a user interface presented via a display according to another aspect of the subject matter described herein;

FIG. 7 is a message flow diagram illustrating an exemplary data and execution flow for processing a reference in a communication to a remote data object according to an aspect of the subject matter described herein;

FIG. 8A illustrates an exemplary portion of a communication between a first execution environment and a second execution environment according to an aspect of the subject matter described herein; and

FIG. 8B illustrates another exemplary portion of a communication between a first execution environment and a second execution environment according to an aspect of the subject matter described herein.

### DETAILED DESCRIPTION

One or more aspects of the disclosure are described with reference to the drawings, wherein like reference numerals are generally utilized to refer to like elements throughout, and wherein the various structures are not necessarily drawn to scale. In the following description, for purposes of explanation, numerous specific details are set forth in order to provide a thorough understanding of one or more aspects of the disclosure. It may be evident, however, to one skilled in the art, that one or more aspects of the disclosure may be practiced with a lesser degree of these specific details. In other instances, well-known structures and devices are shown in block diagram form in order to facilitate describing one or more aspects of the disclosure.

Unless otherwise defined, all technical and scientific terms used herein have the same meaning as commonly understood by one of ordinary skill in the art to which this disclosure belongs. Although methods, components, and devices similar or equivalent to those described herein can be used in the practice or testing of the present invention, suitable methods, components, and devices are described below.

All publications, patent applications, patents, and other references mentioned herein are incorporated by reference in their entirety. In case of conflict, the present specification, including definitions, will control. In addition, the materials, methods, and examples are illustrative only and not intended to be limiting.

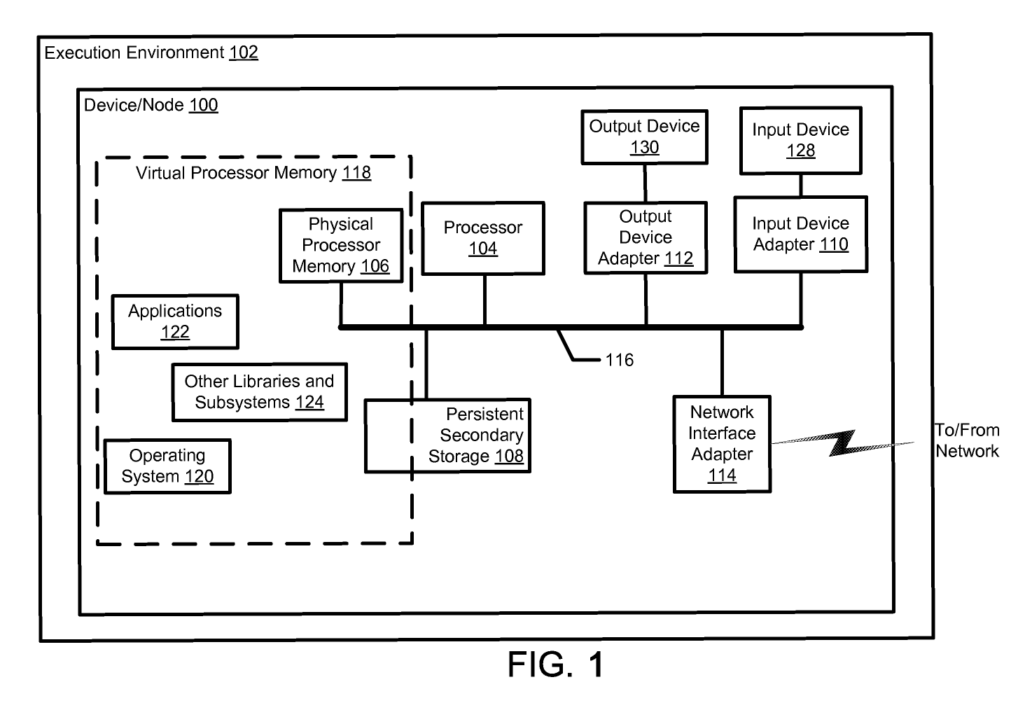

An exemplary device included in an execution environment that may be configured according to the subject matter is illustrated in FIG. 1. An “execution environment”, as used herein, is an arrangement of hardware and, in some aspects, software that may be further configured to include and/or otherwise host an arrangement of components for performing a method of the subject matter described herein. An execution environment includes and/or is otherwise provided by one or more devices. An execution environment may be and/or may include a virtual execution environment including software components operating in a host execution environment. Exemplary devices included in and/or otherwise providing suitable execution environments for configuring according to the subject matter include personal computers, notebook computers, tablet computers, servers, portable electronic devices, handheld electronic devices, mobile devices, multiprocessor devices, distributed systems, consumer electronic devices, routers, communication servers, and/or any other suitable devices. Those skilled in the art will understand that the components illustrated in FIG. 1 are exemplary and may vary by particular execution environment.

FIG. 1 illustrates a hardware device 100 included in an execution environment 102. FIG. 1 illustrates that execution environment 102 includes a processor 104, such as one or more microprocessors; a physical processor memory 106 including storage locations identified by addresses in a physical memory address space of processor 104; a persistent secondary storage 108, such as one or more hard drives and/or flash storage media; an input device adapter 110, such as a key or keypad hardware, a keyboard adapter, and/or a mouse adapter; an output device adapter 112, such as a display and/or an audio adapter for presenting information to a user; a network interface component, illustrated by a network interface adapter 114, for communicating via a network such as a LAN and/or WAN; and a communication mechanism that operatively couples elements 104-114, illustrated as a bus 116. Elements 104-114 may be operatively coupled by various means. Bus 116 may comprise any type of bus architecture, including a memory bus, a peripheral bus, a local bus, and/or a switching fabric.

As used herein a “processor” is an instruction execution machine, apparatus, or device. A processor may include one or more electrical, optical, and/or mechanical components that operate in interpreting and executing program instructions. Exemplary processors include one or more microprocessors, digital signal processors (DSPs), graphics processing units, application-specific integrated circuits (ASICs), optical or photonic processors, and/or field programmable gate arrays (FPGAs). Processor 104 may access machine code instructions and data via one or more memory address spaces in addition to the physical memory address space. A memory address space includes addresses identifying locations in a processor memory. The addresses in a memory address space are included in defining a processor memory. Processor 104 may have more than one processor memory. Thus, processor 104 may have more than one memory address space. Processor 104 may access a location in a processor memory by processing an address identifying the location. The processed address may be identified by an operand of a machine code instruction and/or may be identified by a register or other portion of processor 104.

FIG. 1 illustrates a virtual processor memory 118 spanning at least part of physical processor memory 106 and may span at least part of persistent secondary storage 108. Virtual memory addresses in a memory address space may be mapped to physical memory addresses identifying locations in physical processor memory 106. An address space for identifying locations in a virtual processor memory is referred to as a virtual memory address space; its addresses are referred to as virtual memory addresses; and its processor memory is referred to as a virtual processor memory or virtual memory. The term “processor memory” may refer to physical processor memory, such as processor memory 106, and/or may refer to virtual processor memory, such as virtual processor memory 118, depending on the context in which the term is used.

Physical processor memory 106 may include various types of memory technologies. Exemplary memory technologies include static random access memory (SRAM) and/or dynamic RAM (DRAM) including variants such as dual data rate synchronous DRAM (DDR SDRAM), error correcting code synchronous DRAM (ECC SDRAM), RAMBUS DRAM (RDRAM), and/or XDR™ DRAM. Physical processor memory 106 may include volatile memory as illustrated in the previous sentence and/or may include nonvolatile memory such as nonvolatile flash RAM (NVRAM) and/or ROM.

Persistent secondary storage 108 may include one or more flash memory storage devices, one or more hard disk drives, one or more magnetic disk drives, and/or one or more optical disk drives. Persistent secondary storage may include a removable data storage medium. The drives and their associated tangible computer readable storage media provide volatile and/or nonvolatile storage for computer-readable instructions, data structures, program components, and other data for execution environment 102.

Execution environment 102 may include software components stored in persistent secondary storage 108, in remote storage accessible via a network, and/or in a processor memory. FIG. 1 illustrates execution environment 102 including an operating system 120, one or more applications 122, and other program code and/or data components illustrated by other libraries and subsystems 124. In an aspect, some or all software components may be stored in locations accessible to processor 104 in a shared memory address space shared by the software components. The software components accessed via the shared memory address space are stored in a shared processor memory defined by the shared memory address space. In another aspect, a first software component may be stored in one or more locations accessed by processor 104 in a first address space and a second software component may be stored in one or more locations accessed by processor 104 in a second address space. The first software component is stored in a first processor memory defined by the first address space and the second software component is stored in a second processor memory defined by the second address space.

Software components typically include instructions executed by processor 104 in a computing context referred to as a “process”. A process may include one or more “threads”. A “thread” includes a sequence of instructions executed by processor 104 in a computing sub-context of a process. The terms “thread” and “process” may be used interchangeably herein when a process includes only one thread.

Execution environment 102 may receive user-provided information via one or more input devices illustrated by an input device 128. Input device 128 provides input information to other components in execution environment 102 via input device adapter 110. Execution environment 102 may include an input device adapter for a keyboard, a touch screen, a microphone, a joystick, a television receiver, a video camera, a still camera, a document scanner, a fax, a phone, a modem, a network interface adapter, and/or a pointing device, to name a few exemplary input devices.

Input device 128 included in execution environment 102 may be included in device 100 as FIG. 1 illustrates or may be external (not shown) to device 100. Execution environment 102 may include one or more internal and/or external input devices. External input devices may be connected to device 100 via corresponding communication interfaces such as a serial port, a parallel port, and/or a universal serial bus (USB) port. Input device adapter 110 receives input and provides a representation to bus 116 to be received by processor 104, physical processor memory 106, and/or other components included in execution environment 102.

An output device 130 in FIG. 1 exemplifies one or more output devices that may be included in and/or that may be external to and operatively coupled to device 100. For example, output device 130 is illustrated connected to bus 116 via output device adapter 112. Output device 130 may be a display device. Exemplary display devices include liquid crystal displays (LCDs), light emitting diode (LED) displays, and projectors. Output device 130 presents output of execution environment 102 to one or more users. In some embodiments, an input device may also include an output device. Examples include a phone, a joystick, and/or a touch screen. In addition to various types of display devices, exemplary output devices include printers, speakers, tactile output devices such as motion-producing devices, and other output devices producing sensory information detectable by a user. Sensory information detected by a user is referred herein to as “sensory input” with respect to the user.

A device included in and/or otherwise providing an execution environment may operate in a networked environment communicating with one or more devices via one or more network interface components. The terms “communication interface component” and “network interface component” are used interchangeably herein. FIG. 1 illustrates network interface adapter (NIA) 114 as a network interface component included in execution environment 102 to operatively couple device 100 to a network. A network interface component includes a network interface hardware (NIH) component and optionally a network interface software (NIS) component.

Exemplary network interface components include network interface controller components, network interface cards, network interface adapters, and line cards. A node may include one or more network interface components to interoperate with a wired network and/or a wireless network. Exemplary wireless networks include a BLUETOOTH network, a wireless 802.11 network, and/or a wireless telephony network (e.g., a cellular, PCS, CDMA, and/or GSM network). Exemplary network interface components for wired networks include Ethernet adapters, Token-ring adapters, FDDI adapters, asynchronous transfer mode (ATM) adapters, and modems of various types. Exemplary wired and/or wireless networks include various types of LANs, WANs, and/or personal area networks (PANs). Exemplary networks also include intranets and internets such as the Internet.

The terms “network node” and “node” in this document both refer to a device having a network interface component for operatively coupling the device to a network. Further, the terms “device” and “node” used herein may refer to one or more devices and nodes, respectively, providing and/or otherwise included in an execution environment unless clearly indicated otherwise.

The user-detectable outputs of a user interface are generically referred to herein as “user interface elements” or abbreviated as “UI elements”. More specifically, visual outputs of a user interface are referred to herein as “visual interface elements”. A visual interface element may be a visual output of a graphical user interface (GUI). Exemplary visual interface elements include windows, textboxes, sliders, list boxes, drop-down lists, spinners, various types of menus, toolbars, ribbons, combo boxes, tree views, grid views, navigation tabs, scrollbars, labels, tooltips, text in various fonts, balloons, dialog boxes, and various types of button controls including check boxes and radio buttons. An application interface may include one or more of the elements listed. Those skilled in the art will understand that this list is not exhaustive. The terms “visual representation”, “visual output”, and “visual interface element” are used interchangeably in this document. Other types of UI elements include audio outputs referred to as “audio interface elements”, tactile outputs referred to as “tactile interface elements”, and the like.

A visual output may be presented in a two-dimensional presentation where a location may be defined in a two-dimensional space having a vertical dimension and a horizontal dimension. A location in a horizontal dimension may be referenced according to an X-axis and a location in a vertical dimension may be referenced according to a Y-axis. In another aspect, a visual output may be presented in a three-dimensional presentation where a location may be defined in a three-dimensional space having a depth dimension in addition to a vertical dimension and a horizontal dimension. A location in a depth dimension may be identified according to a Z-axis. A visual output in a two-dimensional presentation may be presented as if a depth dimension existed allowing the visual output to overlie and/or underlie some or all of another visual output.

A “user interface (UI) element handler” component, as the term is used in this document, includes a component configured to send information representing a program entity for presenting a user-detectable representation of the program entity by an output device, such as a display. A “program entity” is an object included in and/or otherwise processed by an application or executable. The user-detectable representation is presented based on the sent information. Information that represents a program entity for presenting a user detectable representation of the program entity by an output device is referred to herein as “presentation information”. Presentation information may include and/or may otherwise identify data in one or more formats. Exemplary formats include image formats such as JPEG, video formats such as MP4, markup language data such as hypertext markup language (HTML) and other XML-based markup, a bit map, and/or instructions such as those defined by various script languages, byte code, and/or machine code. For example, a web page received by a browser from a remote application provider may include HTML, ECMAScript, and/or byte code for presenting one or more UI elements included in a user interface of the remote application. Components configured to send information representing one or more program entities for presenting particular types of output by particular types of output devices include visual interface element handler components, audio interface element handler components, tactile interface element handler components, and the like.

A representation of a program entity may be stored and/or otherwise maintained in a presentation space. As used in this document, the term “presentation space” refers to a storage region allocated and/or otherwise provided for storing presentation information, which may include audio, visual, tactile, and/or other sensory data for presentation by and/or on an output device. For example, a buffer for storing an image and/or text string may be a presentation space as sensory information for a user. A presentation space may be physically and/or logically contiguous or non-contiguous. A presentation space may have a virtual as well as a physical representation. A presentation space may include a storage location in a processor memory, secondary storage, a memory of an output adapter device, and/or a storage medium of an output device. A screen of a display, for example, is a presentation space.

As used herein, the terms “program” and “executable” refer to any data representation that may be translated into a set of machine code instructions and may optionally include associated program data. The terms are used interchangeably herein. Program representations other than machine code include object code, byte code, and source code. Object code includes a set of instructions and/or data elements that either are prepared for linking prior to loading or are loaded into an execution environment. When in an execution environment, object code may include references resolved by a linker and/or may include one or more unresolved references. The context in which this term is used will make clear the state of the object code when it is relevant. This definition can include machine code and virtual machine code, such as Java™ byte code. As used herein, the terms “application”, and “service” may be realized in one or more executables and/or in one or more hardware components. The terms are used interchangeably herein.

As used herein, the term “network protocol” refers to a formal set of rules, conventions, and data structures that governs how computers and other network devices exchange information over a network. The rules, conventions, and data structures are said to be specified or defined in a specification and/or schema.

The term “network path” as used herein refers to a sequence of nodes in a network that are communicatively coupled for transmitting data in one or more data units of a specified network protocol between a pair of nodes in the network.

A “data unit”, as the term is used herein, is an entity specified according to a network protocol for transmitting data between a pair of nodes in a network path to send the data from a source node to a destination node that includes a protocol endpoint of the network protocol. A network protocol explicitly and/or implicitly specifies and/or otherwise identifies a schema that defines one or more of a format for a valid data unit and a vocabulary for content of a valid data unit. One example of a data unit is an Internet Protocol (IP) packet. The Internet Protocol defines a format for an IP packet that defines a header for identifying a destination address that identifies a destination node and a payload portion for including a representation of data to be delivered to the identified destination node. The terms “data unit”, “data packet” and “packet” are used interchangeably herein. One or more data units of a first network protocol may transmit a message of second network protocol. For example, one or more data units of the IP protocol may include a TCP message. In another example, one or more TCP data units may transmit an HTTP message.

How data is packaged in one more data units for a network protocol may vary as the data traverses a network path from a source node to a destination node. Data may be transmitted in a single data unit between two consecutive nodes in a network path. Additionally, data may be exchanged between a pair of consecutive nodes in several data units each including a portion of the data. Data received in a single data unit by a node in a network path may be split into portions included in several respective data units for transmitting to a next node in the network path. Portions of data received in several data units may be combined into a single data unit for transmitting by a node in a network path. For purposes of describing the subject matter, a data unit in which data is received by a node is referred to as a different data unit than a data unit in which the data is forwarded by the node.

A “protocol address”, as the term is used herein, for a network protocol is an identifier of a protocol endpoint that may be represented in a data unit of the protocol. For example, 192.168.1.1 is an IP protocol address represented in a human readable format that may be included in an address portion of an IP header to identify a source and/or a destination IP protocol endpoint. A protocol address differs from a symbolic identifier, defined below, in that a symbolic identifier, with respect to a network protocol, maps to a protocol address. Thus, “www.mynode.com” may be a symbolic identifier for a node in a network when mapped to the protocol address 192.168.1.1. An identifier may be both a symbolic identifier and a protocol address depending on its role with respect to its use for a particular network protocol.

A node in a pair of nodes in a network path at one end of the sequence of nodes in the network path and/or the other end is referred to herein as a “path end node”. Note that a node may have two NICs with one NIC at each end of a network path. A network path may be included as a portion of another network path that communicatively couples a same pair of nodes. Data may be transmitted via the sequence of nodes in a network path between path end nodes communicatively coupled via the network path. Data may be transmitted in one or both directions depending on an ordering of the nodes in the sequence.

“Path information” is any information that identifies a network path and/or hop path for data transmitted via one or more specified network protocols. Path information may be identified by identifying network interfaces, NICs, nodes, and/or hops included in a network path. “Address information” is any information that identifies a protocol address that, for a network protocol, identifies a protocol endpoint. Address information may identify a unicast protocol address for a network protocol. In identifying a protocol endpoint, a protocol address identifies a node and a network interface. Those skilled in the art will understand upon reading the descriptions herein that the subject matter disclosed herein is not restricted to the network protocols described and/or their corresponding OSI layers. For ease of illustration, the subject matter is described in terms of protocols that correspond to OSI layer three, also referred to as network layer protocols, in general. Particular descriptions are based on versions of the Internet Protocol (IP). Address information may identify one or more protocol addresses. Exemplary protocol addresses include IP addresses, IPX addresses, DECNet addresses, VINES Internet Protocol addresses, and Datagram Delivery Protocol (DDP) addresses.

An “interaction”, as the term is used herein, refers to any activity including a user and an object where the object is a source of sensory data detected by the user. In an interaction, the user directs attention to the object. An interaction may also include the object as a target of input from the user. The input from the user may be provided intentionally or unintentionally by the user. For example, a rock being held in the hand of a user is a target of input, both tactile and energy input, from the user. A portable electronic device is a type of object. In another example, a user looking at a portable electronic device is receiving sensory data from the portable electronic device whether the device is presenting an output via an output device or not. The user manipulating an input component of the portable electronic device exemplifies the device, as an input target, receiving input from the user. Note that the user in providing input is detecting sensory information from the portable electronic device provided that the user directs sufficient attention to be aware of the sensory information and provided that no disabilities prevent the user from processing the sensory information. An interaction may include an input from the user that is detected and/or otherwise sensed by the device. An interaction may include sensory information that is detected by a user included in the interaction that is presented by an output device included in the interaction.

As used herein, any reference to an entity “in” an association is equivalent to describing the object as “identified” by the association, unless explicitly indicated otherwise.

As used herein, the term “communication” refers to information including a message sent and/or for sending via a network between communicants. The term “communicant” as used herein refers to a user included in a communication as a sender and/or a receiver of the information. A communicant is represented by a “communications agent” configured to operate in an execution environment to send data to and/or receive data from another communications agent, on behalf of the represented communicant, according to a communications protocol via network. A communications protocol defines and/or otherwise identifies an address space including communications addresses for delivering data sent in a communication from one communications agent to another.

The term “communicant alias” as used herein refers to an identifier of a communicant in a communication where the communicant alias is not a communications address included in an address space of a communications protocol for sending and/or receiving data in the communication.

The term “attachment” as used herein refers to a portion of a communication that includes data from one communicant to another other than data in the message portion. A resource sent as an attachment is data that is typically not presented “inline” or in a message included in a message portion of a communication. Email attachments are perhaps the most widely known attachments included in communications. An email attachment is a file or other resource sent along with an email in a portion of the email separate from a message portion. As defined, other types of text communications as well as voice and video communications may include mount descriptor portions. A communication may include one or more resources as one or more attachments.

The terms “contactor” and “contactee” identify roles in a communication. A “contactor” provides information for identifying a “contactee” in a communication. A contactee may be included in a communication by a contactor and/or the contactor's communications agent. A contactor and/or a contactee are users of a communications agent and may be a living being, a node, a component, and/or an application. Both a contactor and a contactee are communicants in a communication.

The term “remote attachment descriptor” as used herein refers to

The term “data object” as used herein refers to an entity, identifiable within a data store, for storing and/or accessing data. Exemplary data stores include file systems, directory service including DNS and LDAP, and data bases including relational databases and hierarchical databases, to name a few examples. Exemplary data objects include files and folders in a file system as each. Accessing a data object includes one or more of accessing data in the data object and accessing metadata, maintained by the data store, about the data object.

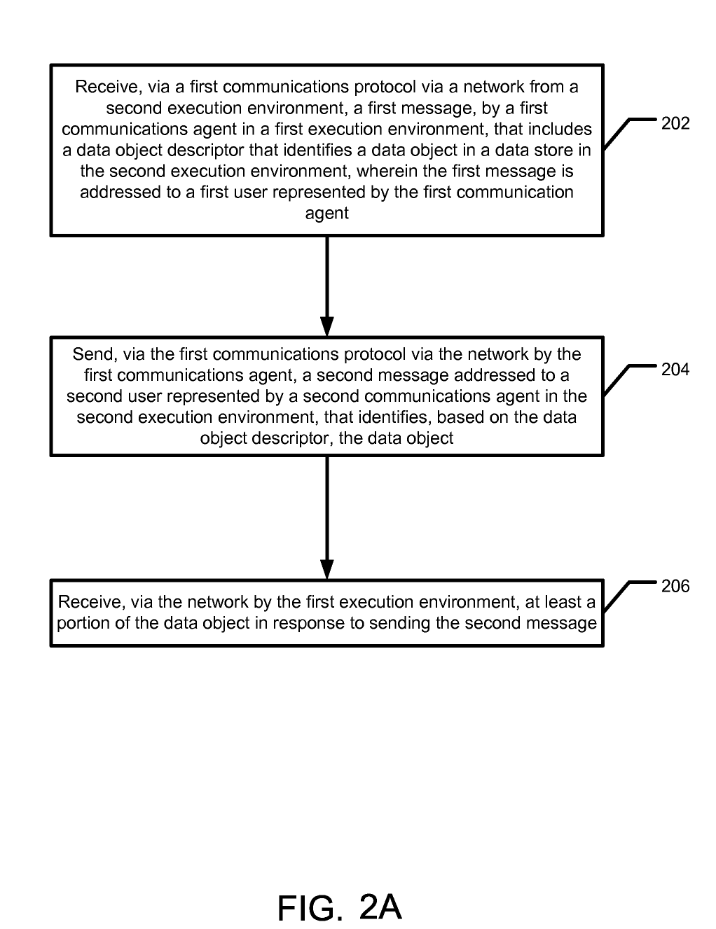

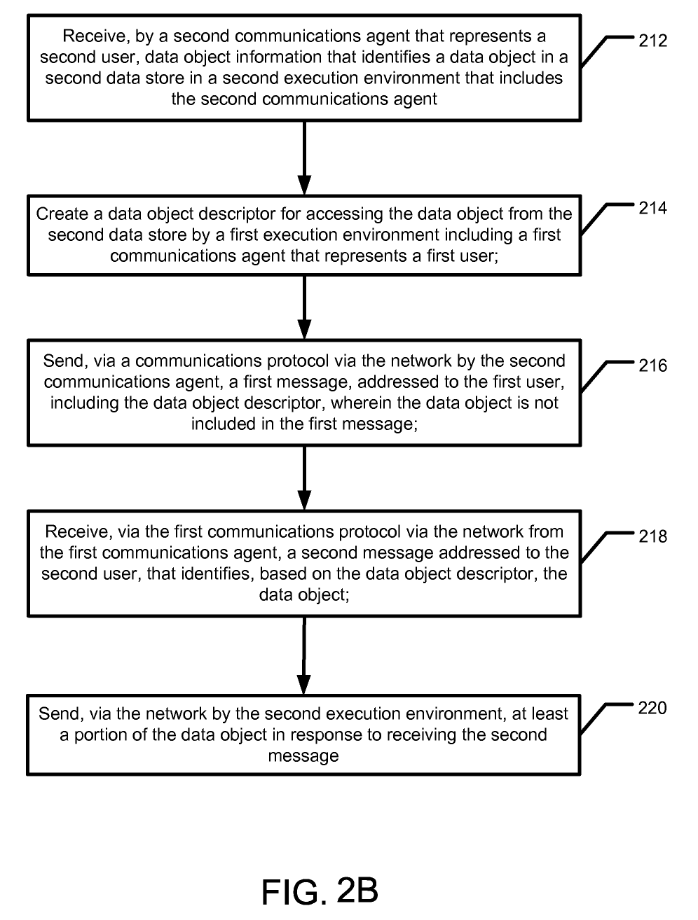

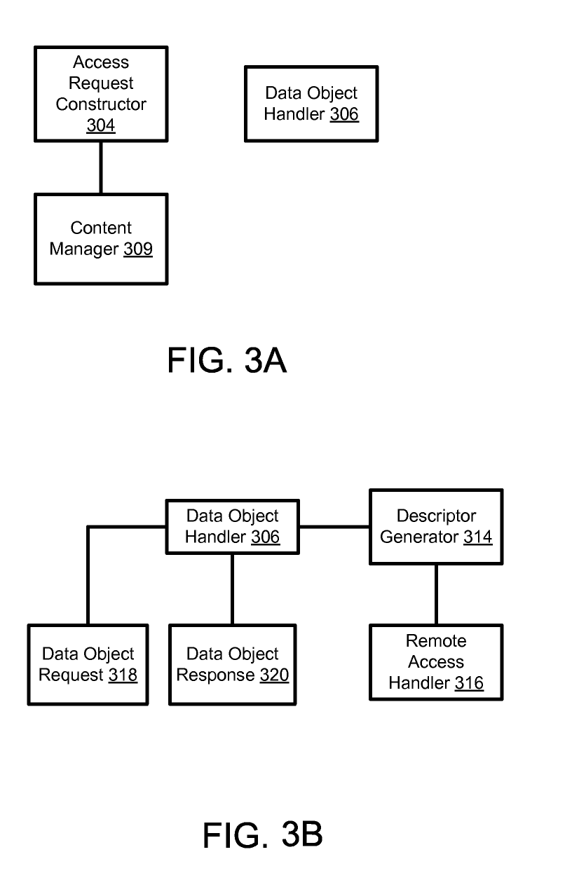

FIG. 3A illustrates an arrangement of components in a system that operates in an execution environment, such as execution environment 102 in FIG. 1. The arrangement of components in the system operates to perform the method illustrated in FIG. 2A. The system illustrated includes a content manager component 309, an access request constructor component 304, and a data object handler component 306. A suitable execution environment includes a processor, such as processor 104, to process an instruction in at least one of a content manager component, an access request constructor component, and a data object handler component. FIG. 3B illustrates an arrangement of components in a system that operates to perform the method illustrated in FIG. 2B. The system illustrated includes a data object handler component 306, a descriptor generator component 314, a remote access handler component 316, a data object request component 318; and a data object response component 320. A suitable execution environment includes a processor, such as processor 104, to process an instruction in at least one of a data object handle component, a descriptor generator component, a remote access handler component, a data object request component, and a data object response component.

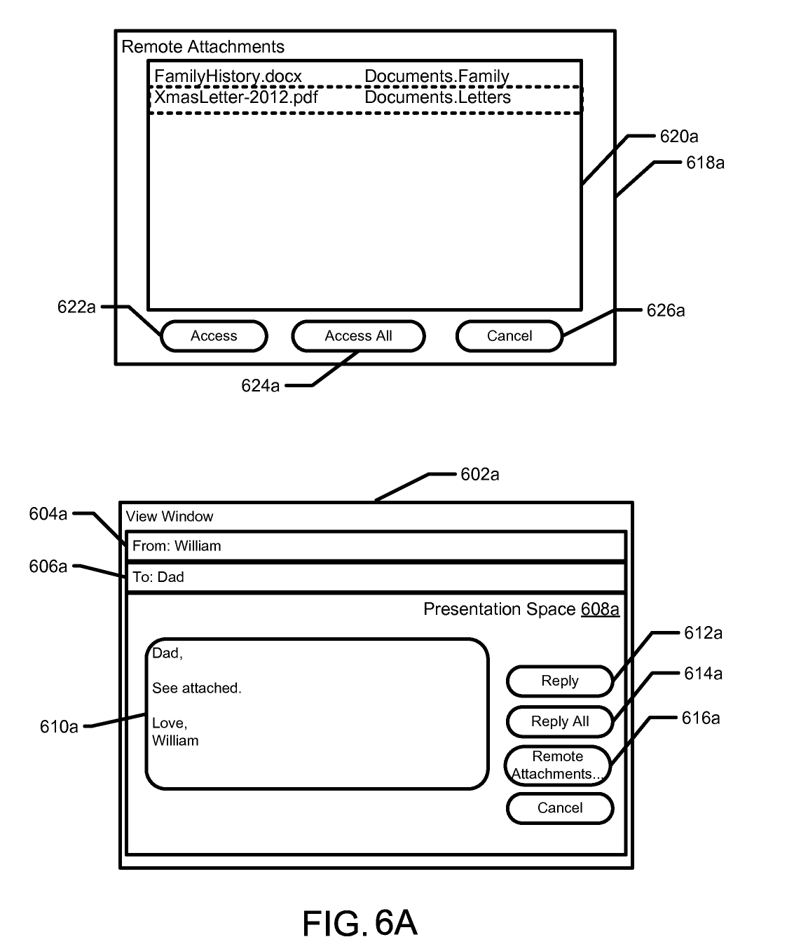

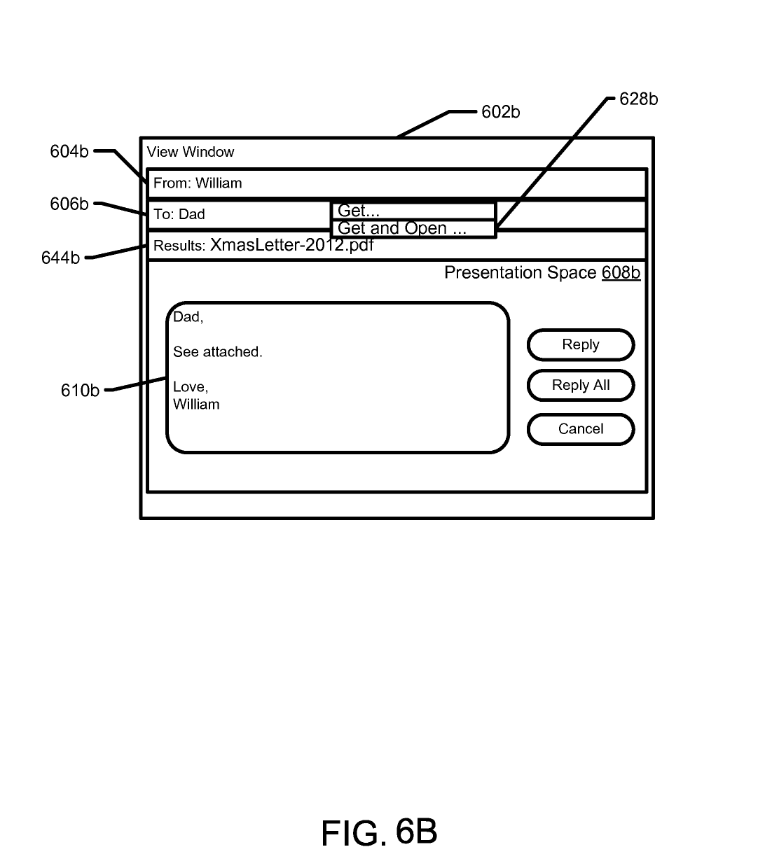

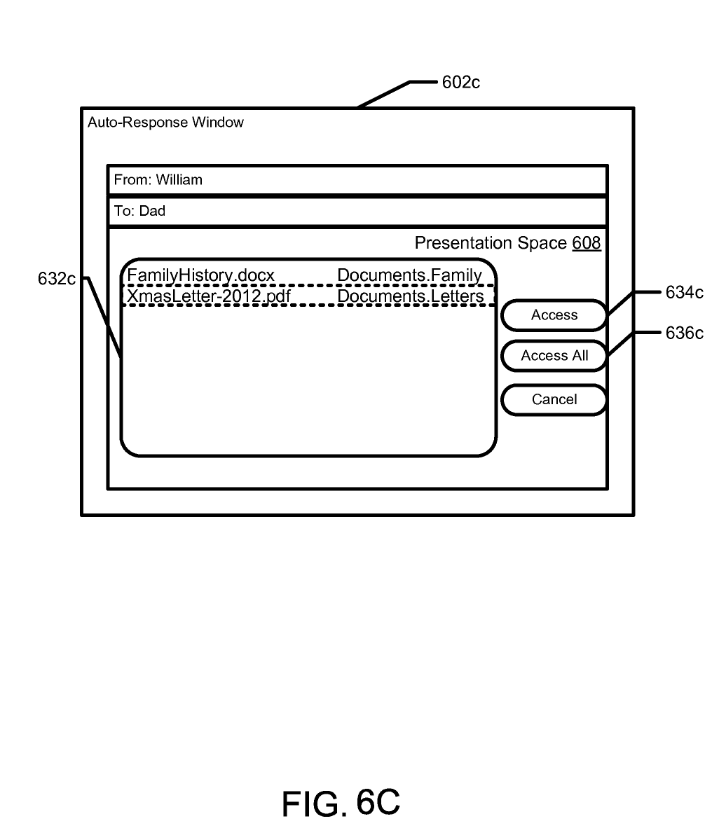

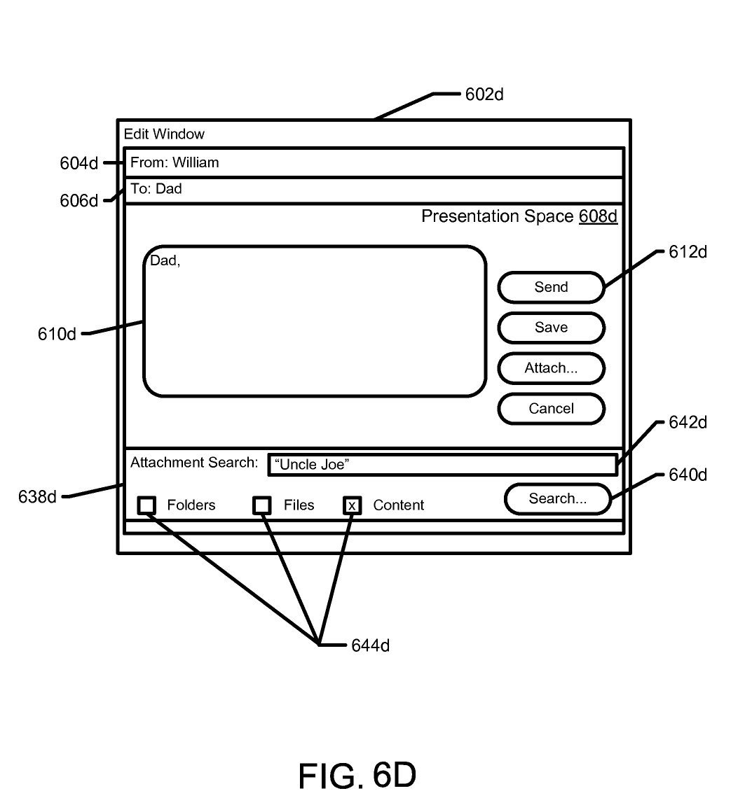

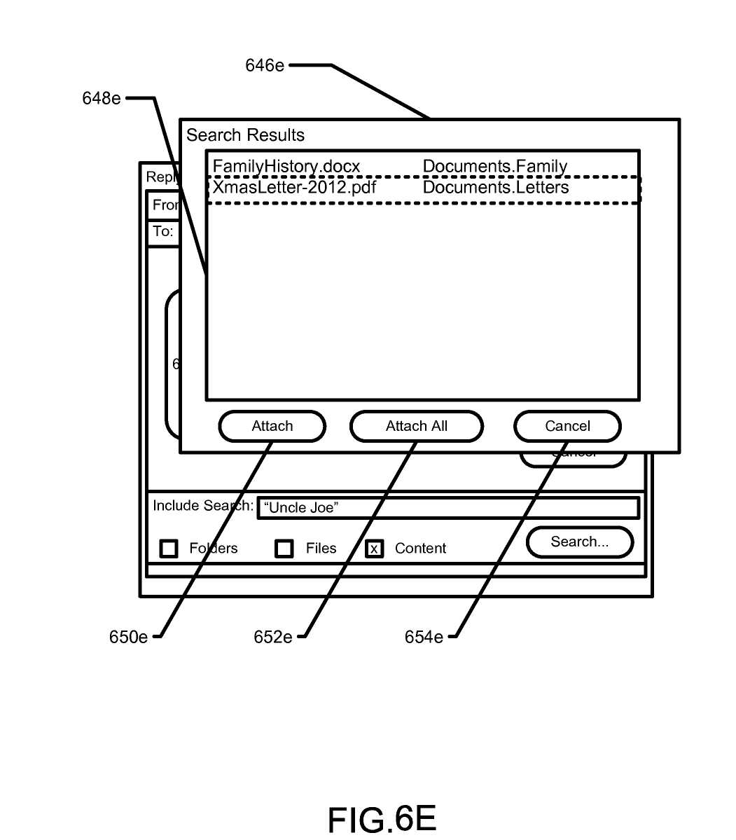

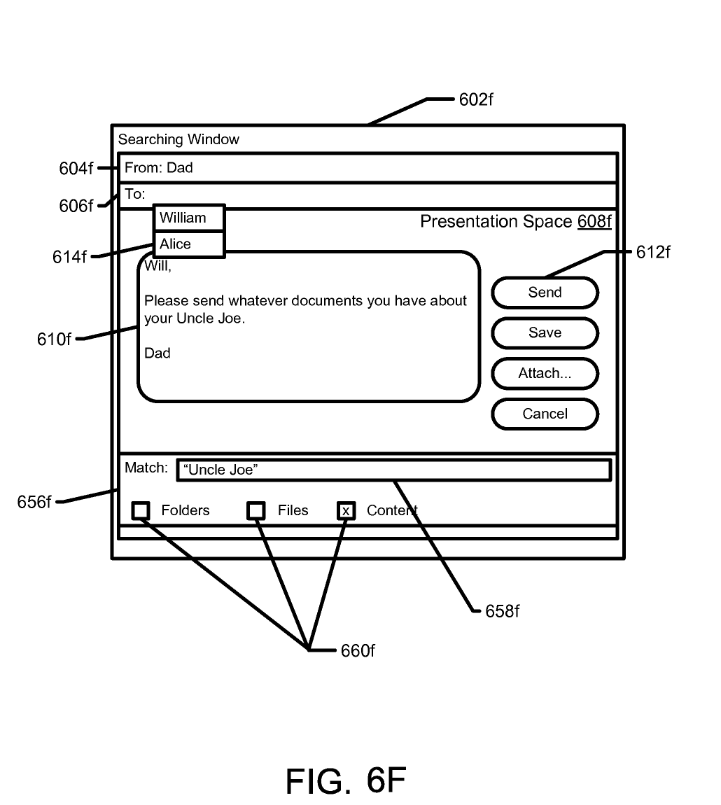

Some components, illustrated in the drawings are identified by numbers with an alphanumeric suffix. A component may be referred to generically in the singular or the plural by dropping a suffix of a portion thereof of the component's identifier. For example, window UI elements, such as a window UI element 602a in FIG. 6A, a window UI element 602b in FIG. 6B, and their adaptations and analogs; are referred to herein generically as a window UI element 602 or window UI elements 602 when describing more than one. Other components identified with an alphanumeric suffix may be referred to generically or as a group in a similar manner.

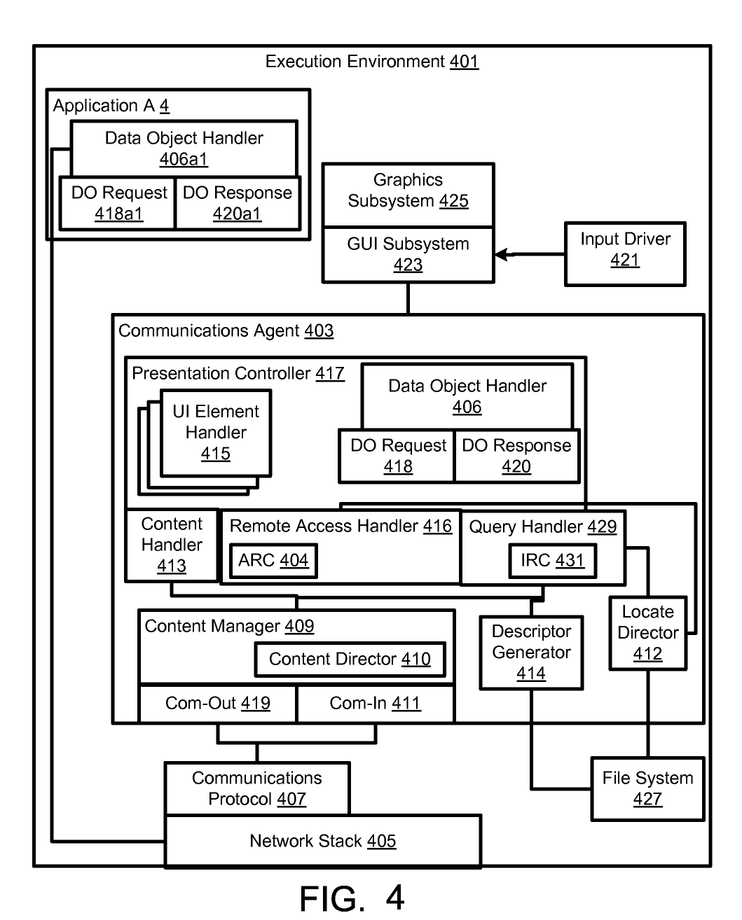

The arrangement components illustrated in FIG. 4 may be adapted to operate in a number of execution environments to perform the method illustrated in FIG. 2A and/or the method illustrated in FIG. 2B. FIG. 4 is a block diagram illustrating the components of FIG. 3A, FIG. 3B, and/or analogs of the components of FIG. 3A and FIG. 3B, respectively adapted to operate in an execution environment 401 that includes and/or otherwise is provided by one or more nodes. FIG. 1 illustrates key components of an exemplary device that may at least partially provide and/or otherwise be included in an execution environment. The components illustrated in FIG. 4 may be included in or otherwise combined with the components of FIG. 1 to create a variety of arrangements of components according to the subject matter described herein.

As stated, the various adaptations of the arrangement in FIG. 3A as well as the various adaptations of the arrangement in FIG. 3B illustrated and described herein are not exhaustive. For example, those skilled in the art will see based on the description herein that arrangements of components for performing the method illustrated in FIG. 2A and the method illustrated in FIG. 2B may each be distributed across more than one node and/or execution environment. For example, such an arrangement may operate at least partially in a browser in a one node and at least partially in a server in another node interoperating via a network.

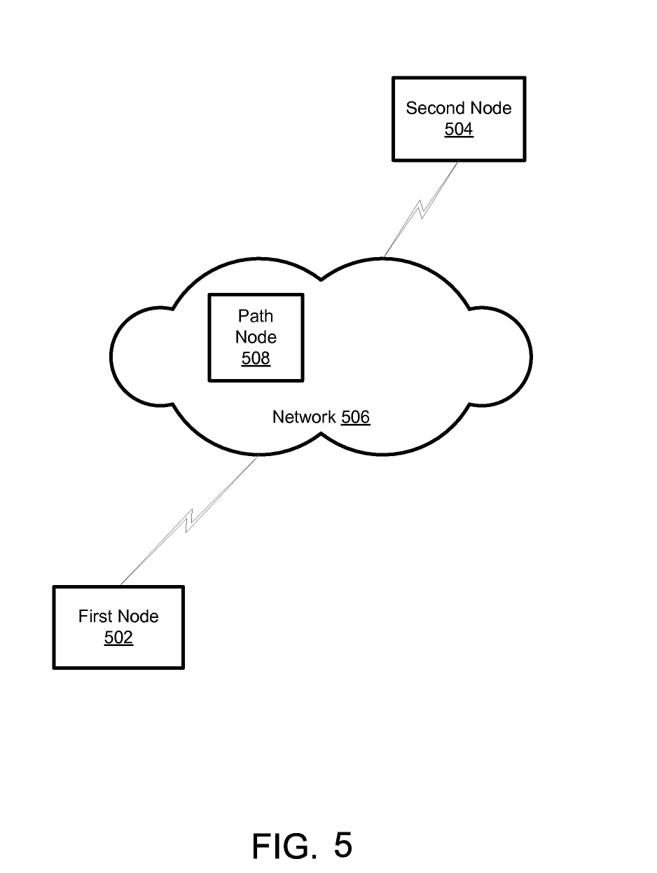

FIG. 5 illustrates a first node 502 and a second node 504 as exemplary devices that each may be included in and/or otherwise adapted for providing an instance, adaptation, and/or analog of an execution environment 401 in FIG. 4. As illustrated in FIG. 5, execution environment 401 of first node 502 and execution environment 401 of second node 504 are operatively coupled to a network 506 via respective network interface components enabling execution environment 401 of first node 502 and execution environment 401 of second node 504 to exchange data in a communication on behalf of communicants represented by the respective execution environments.

FIG. 4 illustrates communications agent 403 including an adaptation of the arrangement of components in FIG. 3A and an adaptation of the arrangement of components in FIG. 3B. A communications agent 403 may operate, in a first execution environment 401 of first node 502, on behalf of a first communicant to communicate with a second communicant represented by a second communications agent 403 operating in a second execution environment 401 of second node 504.

Components in FIG. 4 are referenced for illustrative purposes in describing communications agents operating in an execution environment of first node 502 and an execution environment of second node 504. Exemplary communications agents include email clients, phone clients including Voice over Internet Protocol (VoIP) clients, instant messaging clients, short message service (SMS) clients, multimedia message service (MMS clients), multi-media communications clients including video phone clients, and other data transfer agents.

Communications agents 403 in FIG. 4, respectively operating in execution environment 401 of first node 502 and in execution environment 401 of second node 504 in FIG. 5 may interoperate via respective network stacks 405. Communications agents 403 may communicate via one or more communications protocols. FIG. 4 illustrates communications protocol component 407 exemplifying a subsystem for exchanging data via network 506 according to one or more communications protocols, such as simple mail transfer protocol (SMTP), an instant messaging protocol, and/or a real-time voice and/or video protocol. A communication between communications agents 403 in execution environment 401 of first node 502 and execution environment 401 of second node 504 may include more than one type of data and may use one or more communications protocols in exchanging one or more types of data via network 506.

Instances, adaptations, and/or analogs of communications agent 403 in FIG. 4, in execution environment 401 of first node 502 and in execution environment 401 of second node 504, respectively, may communicate via discrete messages, a request/reply protocol, a data streaming protocol, a session and/or connection-oriented protocol, a connectionless protocol, a real-time communications protocol, an asynchronous communication, a store and forward communications protocol, a reliable delivery communications protocol, a best-effort delivery communications protocol, and/or a secure protocol, to name a few communications options.

FIG. 4 illustrates communications agent 403 including a content manager component 409. Content manager component 409 may interoperate with communications protocol component 407 and/or network stack 405 to receive data in one or more communications via network 506 with another communications agent in another execution environment. Content manager component 409 is operatively coupled, via com-in component 411, to communications protocol component 407 to receive the data from the other execution environment.

Data received in a communication may include one or more resources and/or content types. Exemplary content types include plain text, markup such as hypertext markup language (HTML), audio data, image data, and/or executable data. Executable data may include script instruction(s), byte code, and/or machine code. In FIG. 4, communications agent 403 includes one or more content handler components 413 to process data received according to its content type. A data type may be identified by a MIME type identifier. Exemplary content handler components 413 include a text/html content handler component for processing HTML representations; an application/xmpp-xml content handler component for processing extensible messaging and presence protocol (XMPP) streams including presence tuples, instant messages, and audio content handlers including and/or configured to retrieve suitable codices; one or more video content handler components for processing video representations of various types; and still image data content handler components for processing various image data representations.

Content handler component(s) 413 process received data representations and may provide transformed data from the representations to one or more user interface element handler components 415. One or more user interface element handler components 415 are illustrated in a presentation controller component 417 in FIG. 4. Presentation controller component 417 may manage visual, audio, and other types of output for its including application as well as receive and route detected user and other inputs to components and extensions of its including application, communications agent 403. A user interface element handler component 415 may be adapted to operate at least partially in a content handler component 413 such as a text/html content handler component and/or a script content handler component. Additionally or alternatively, a user interface element handler component in an execution environment 401 may be received in a communication. For example, a communication, such as an email, may include an HTML content type portion and a script content type portion.

FIG. 6A-F illustrates various window UI elements 602 presentable in a presentation space of a display device, such as output device 130 in FIG. 1. A window UI element 602 may include a contactor user interface (UI) element 604 for presenting an identifier of a communicant in the role of a contactor in a communication represented by the window UI element 602. A window UI element 602 also may include a contactee UI element 606 for presenting one or more contactee identifier(s) identifying one or more communicants in the role of contactee(s) included in the communication. A presentation space 608 may be provided by each window UI element 602 for presenting a text message UI element 610 that may present a message or a portion thereof from the contactee to one or more contactees identified in a contactee UI element 606. A presentation space 608 may also be provided for presenting one or more UI controls for exchanging data in and/or otherwise managing a message in a communication.

Data to be sent in a communication to a communications agent in execution environment 401 of second node 504 may be received by one or more content handler component(s) 413 operating in execution environment 401 of first node 502 to transform the data into one or more data representations suitable for transmitting in the communication and/or suitable for processing by the communications agent in execution environment 401 of second node 504. The one or more data representations may be provided to content manager component 409 to send in the communication to execution environment 401 of second node 504. Content manager component 409 may package the one or more data representations in a message formatted according to a communications protocol of the communications agent. Communications protocol component 407 may send the data according to the specification(s), which defines a schema, for the communications protocol. Content manager component 409 may, alternatively or additionally, encode and/or otherwise transform one or more of the data representations to be sent in a data stream such as voice stream and/or a video stream to communicate in the communication to a communications agent via a network.

Content manager component 409 operating in execution environment 401 included in and/or otherwise provided by first node 502 may provide the packaged, encoded, and/or transformed data to communications protocol component 407 via a com-out component 419. Com-out component 419, as described above, operatively couples content manager component 409 to communications protocol component 407 according to an interface provided by communications protocol component 407 to send data in a communication according to a communications protocol. Communications protocol component 407 may further package and/or otherwise transform the data to send via network stack 405 for delivery via network 506 to execution environment 401 of second node 504.

As described above, a communications protocol may operate via one or more nodes in a network in a network path communicatively coupling a first node and a second node. Exemplary path nodes include mail relay nodes, phone switch nodes, and proxy nodes such as instant messaging proxies for communicating through firewalls. As indicated, path node 508 illustrates such a node.

In sending data in a communication, a contactee may be represented and/or otherwise identified by a communications address in an address space of a communications protocol. In one aspect, information identifying a communications address may be received from a communicant of a communications agent in a sending execution environment 401. In FIG. 4, presentation controller 417 and/or a UI element handler 415, presenting and/or managing interaction with contactor UI element 604 in FIG. 6A for first node 502, may receive a contactor alias in response to a user input corresponding to UI element handler 604. The communicant of execution environment 401 of first node 502 may enter a contactor alias, such as “Dad”, via a keyboard and/or select a predefined communicant alias presented in a selection UI control element via a UI element handler component 415. The user input may be detected by input driver 421. Corresponding input information may be routed to presentation controller 417 by GUI subsystem 423. GUI subsystem 423 may send presentation information to a display device by interoperating with a graphics subsystem 425. Communication agent 403 may identify a communication address associated with the contactor alias, “Dad”. Other communications addresses, such as for one or more contactees, may be received similarly and/or in any other suitable manner.

Data may be sent in a communication according to a form or type of the communication and/or other attribute of the communication such as a security attribute, the amount of data to be sent, a priority setting, a task setting, and the like. Some forms of communication do not require a session and/or connection between a first execution environment and a second execution environment in order to send data between the two execution environments, while others do. An email and/or instant message may use a store and forward model of delivery.

Data may be sent in a communication in response to a user input. A contactor may provide an input corresponding to send UI element 612d in FIG. 6D. The input may be received by presentation controller component 417 and/or one or more UI element handlers 415 corresponding to send UI element 612d. In response to detecting the input, presentation controller component 417 may provide data to be sent in the communication to one or more content handler components 413 according to the content type(s) of the data to be sent.

The one or more content handler components 413 may encode, format, and/or otherwise transform the data to send in a message, such as an email message. The one or more content handler components 413 may provide data to be sent to content manager 409, instructing content manager component 409 to send the data in the communication for delivery to a communications agent in execution environment 401 of second node 504. Content manager component 409 interoperating with com-out component 419 may further format and/or transform the data for sending in the communication according to a communications protocol, for example according to an email communications protocol, by communications protocol component 407. Communications protocol component 407 may send the communication for delivery to the communications agent in execution environment 401 of second node 504 via network 506.

Path node 508 may relay data sent in the communication between first node 502 and execution environment 401 of second node 504. Path node 508 may determine a next node and/or a network interface in a network path communicatively coupling first node 502 and execution environment 401 of second node 504 for exchanging data in a communication between communication agents 403 in the first node 502 and in the execution environment 401 of second node 504.

For session-oriented and/or connection-oriented communication, a session and/or connection may be established. Data may be sent for delivery to a communications agent identified based on a contactee communications address during session and/or connection setup. For example, for a voice communication a voice communication session may be established via a session initiation protocol. Communications protocol component 407 may operate according to the session initiation protocol specification. Communications protocol component 407 operating in first node 502 may locate a communications agent by communicating with one or more nodes in network 506 according to the session initiation protocol. Communications protocol component 407 may locate a communications agent in execution environment 401 of second node 504, based on a communications address for the contactee located based on the contactor alias.

Once a communication session is established, such as a voice session, data may be sent according to the session communications protocol, such as RTP. Data may be sent according to the session initiation protocol in the communication to manage the voice communication session and/or to exchange text, image, and/or other data outside of the voice session. Path node 508 may be included in session and/or connection setup. Alternatively or additionally, path node 508 may be included in a network path in a session and/or connection.

With reference to FIG. 2A, a block 202 illustrates that the method includes receiving, via a first communications protocol via a network from a second execution environment, a first message, by a first communications agent in a first execution environment, that includes a data object descriptor that identifies a data object in a data store in the second execution environment, wherein the first message is addressed to a first user represented by the first communication agent. Accordingly, a system for processing a reference in a communication to a remote data object includes means for receiving, via a first communications protocol via a network from a second execution environment, a first message, by a first communications agent in a first execution environment, that includes a data object descriptor that identifies a data object in a data store in the second execution environment, wherein the first message is addressed to a first user represented by the first communication agent. For example, the arrangement in FIG. 3A, includes content manager component 309 that is operable for receiving, via a first communications protocol via a network from a second execution environment, a first message, by a first communications agent in a first execution environment, that includes a data object descriptor that identifies a data object in a data store in the second execution environment, wherein the first message is addressed to a first user represented by the first communication agent. FIG. 4 illustrates content manager component 409 as an adaptation and/or analog of the content manager component 309 in FIG. 3A. One or more components 409 operate in an execution environment 401. The system for processing a reference in a communication to a remote data object includes one or more processors and logic encoded in one or more tangible media for execution by the one or more processors that when executed is operable for receiving, via a first communications protocol via a network from a second execution environment, a first message, by a first communications agent in a first execution environment, that includes a data object descriptor that identifies a data object in a data store in the second execution environment, wherein the first message is addressed to a first user represented by the first communication agent. In FIG. 4, content manager component 409 is illustrated as a component of communications agent 403.

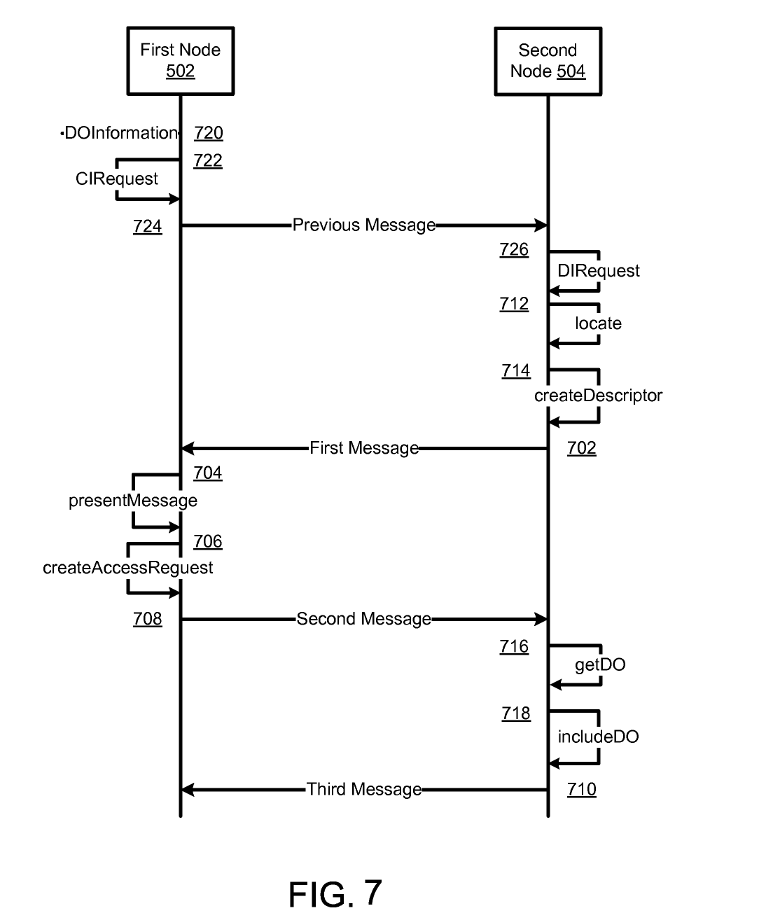

FIG. 7 illustrates a first message 702, including a data object descriptor, received via network 506 by execution environment 401 of first node 502 from execution environment 401 of second node 504.

Content manager component 409 operating in execution environment 401 of first node 502 may interoperate with communications protocol component 407 and/or network stack 405 to receive data in one or more communications via network 506 with another communications agent in another node. A remote access handler component 416 may receive some or all of the communication in receiving and/or otherwise identifying a data object descriptor in the communication. Content manager component 409 in FIG. 4 operatively couples remote access handler component 416 with network 506, via com-in component 411, communications protocol component 407 and/or network stack 405 to receive the data from the other execution environment. Thus, execution environment 401 of first node 502 may receive a communication, via content manager component 409 that includes a data object descriptor.

Com-in component 411 may provide data received in a communication to content manager component 409. Content handler component 409 may identify a data object descriptor in the communication sent from the execution environment 401 of second node 504. Content manager component 409 may interoperate with remote access handler component 416 in identifying the data object descriptor. The data object descriptor may be identified by content manager component 409 according to a schema for the communication. For example, a portion of an email message may include a MIME-type identifier that identifies a corresponding part of the email as a data object descriptor and/or otherwise identifies the part for routing to a remote access handler component 416 to detect the data object descriptor.

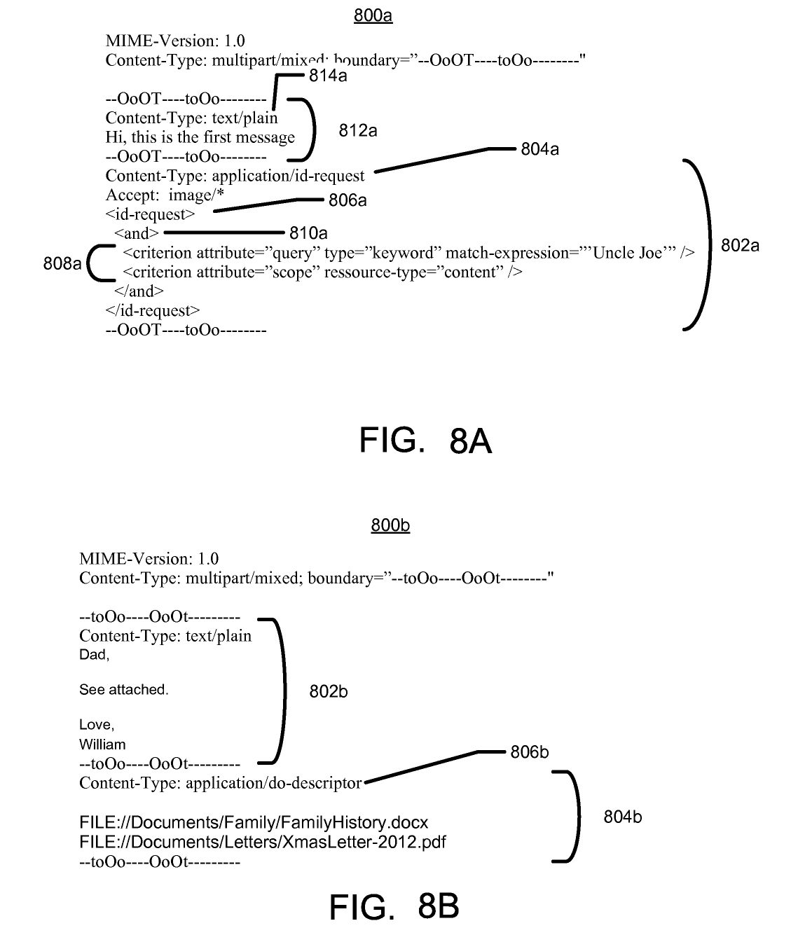

Data sent in first message 702, by execution environment 401 of second node 504, may be received by com-in component 411 operating in an instance, adaptation, and/or analog of execution environment 401 including and/or provided by first node 502. The received communication may include a user readable message addressed to the a communicant represented by communications agent 403 in execution environment 401 of first node 502 and a data object descriptor identifying a data object in a data store of execution environment 401 of second node 504. Content manager component 409 may detect the text message, such as message portion 802b in FIG. 8B in first message 702. Content manager component 409 may detect a data object descriptor, such as data object descriptor portion 804b in FIG. 8B in first message 702. Text message portion 802b and data object descriptor portion 804b may be provided to suitable content handler components 413 based on the content types of the text message portion and the data object descriptor portion detected by content manager component 409. Data object descriptor portion 804b, illustrated in FIG. 8B, may be provided to remote access handler component 416, illustrated in FIG. 4, as a content handler that matches the MIME type field 806b illustrated in FIG. 8B.

Returning to FIG. 2A, a block 204 illustrates that the method further includes sending, via the first communications protocol via the network by the first communications agent, a second message addressed to a second user represented by a second communications agent in the second execution environment, that identifies, based on the data object descriptor, the data object. Accordingly, a system for processing a reference in a communication to a remote data object includes means for sending, via the first communications protocol via the network by the first communications agent, a second message addressed to a second user represented by a second communications agent in the second execution environment, that identifies, based on the data object descriptor, the data object. For example, the arrangement in FIG. 3A, includes access request constructor (ARC) component 304 that is operable for sending, via the first communications protocol via the network by the first communications agent, a second message addressed to a second user represented by a second communications agent in the second execution environment, that identifies, based on the data object descriptor, the data object. FIG. 4 illustrates access request constructor component 404 as an adaptation and/or analog of access request constructor component 304 in FIG. 3A. One or more access request constructor components 404 operate in an execution environment 401. The system for processing a reference in a communication to a remote data object includes one or more processors and logic encoded in one or more tangible media for execution by the one or more processors that when executed is operable for sending, via the first communications protocol via the network by the first communications agent, a second message addressed to a second user represented by a second communications agent in the second execution environment, that identifies, based on the data object descriptor, the data object. In FIG. 4, access request constructor component 404 is illustrated as a component of communications agent 403.

FIG. 7 includes a dataflow that illustrates a present message 704 that may be internal to execution environment 401 of first node 502 and/or may include a message sent to a remote execution environment, such as an execution environment including a browser to send presentation information to present, via an output device, a representation of the data object descriptor received in first message 702. FIG. 7 also includes a dataflow that illustrates a create access request message 706 that may be internal to execution environment 401 of first node 502 and/or may include a message received via network 506 by execution environment 401 of first node 502. In create access request message 706 an access request constructor (ARC) component 404 operating in execution environment 401 of first node. 702 may be invoked to operate. A data object descriptor received in first message 702 may be identified to and/or otherwise by ARC component 404 as part of and/or in response to being invoked.

Remote access handler component 416 may be a type of content handler component 413 that operates to process data representations in a message and may provide transformed data from the representations to one or more user interface element handler components 415. Remote access handler component 416 may operate to process data object descriptors according to a schema defining and/or otherwise for validating data object descriptors. Content manager component 409 may provide and/or otherwise identify various portions of a message, such as a data object descriptor, to one or more content handler components 413. The data object descriptor may be provided to remote access handler component 416. In an aspect, remote access handler component 416 may interoperate with the presentation controller component 417 in the execution environment 401 of first node 502 to present the data received in the data object descriptor and/or other data received in the message.

FIG. 6A illustrates a view window UI element 602a as an exemplary user interface that may be presented by communications agent 403 operating in execution environment 401 of first node 502 to present data received in a communication from execution environment 401 of second node 504. FIG. 6A illustrates a contactor UI element 604a, a contactee UI element 606a, a presentation space 608a of the view window UI element 602a. Presentation space 608a includes a text message UI element 610a. The various UI elements may be presented by one or more UI element handler components 415 in the communications agent 403 in execution environment 401 of first node 502. A reply UI element 612a and a reply all UI element 614a illustrate UI elements in presentation space 608a presented to allow a user of execution environment 401 of first node 502 to respond and/or otherwise instruct execution environment 401 of first node 502 to perform an operation based on the message received in the communication.

View window UI element 602a in FIG. 6A includes a remote attachments UI element 616a for receiving user input to display a representation of one or more data objects located and/or otherwise identified by execution environment 401 of second node 504 and identified in a data object descriptor received in a message. One or more of the data objects are not included in the message. In response to an input directed to remote attachments UI element 616a, a corresponding UI element handler 415 may interoperate with remote access handler component 416 to present a remote attachments dialog UI element 618a that includes a presentation space 620a to present a user detectable representation and/or identifier of some or all of the data objects identified in the received data object descriptor from execution environment 401 of second node 504. In an aspect, one or more data objects located and/or otherwise identified by execution environment 401 of second node 504 may be included in a message as attachments. In a further aspect, located and/or otherwise identified data objects not included in the message may be identified as described with respect to located and/or otherwise identified remote attachments dialog UI element 618a and/or in any other suitable manner. In yet another aspect, files and/or other data objects identified in a data object descriptor may be illustrated in a manner similar to attachments rather than in a separate UI element as in FIG. 6A, and accessed from execution environment 401 of first node 504 via network 506 as described below.

FIG. 6A illustrates an access UI element 622a and an access all UI element 624a allowing a user to provide user input(s) to instruct communications agent 403 in execution environment 401 of first node 502 to request one or more data objects identified in the data object descriptor.

FIG. 7 includes a dataflow that illustrates a second message 708 that includes an access request to access a data object identified in the data object descriptor received in first message 702. FIG. 7 illustrates the access request is sent via network 506 by execution environment 401 of first node 502 to execution environment 401 of second node 504.

In response to receiving first message 702, execution environment 401 of first node 502 may present, in a manner described above, data received in the message to a user of execution environment 401 of first node 502. FIG. 6B illustrates another view window UI element 602b. Context menu 628b provides UI elements to allow the user to instruct execution environment 401 of first node 502 to retrieve a data object identified in a remote attachments UI element 630b, based on a data object descriptor received from execution environment 401 of second node 504. In response to a user, input corresponding to a context menu item included in context menu 628b a corresponding UI element handler component 415 may invoke ARC component 404 to construct an access request to retrieve one or more data objects identified in the data object descriptor. FIG. 6C illustrates another exemplary user interface that execution environment 401 of first node 602 may present to the user to allow the user to instruct execution environment 401 of first node 502 to construct and send an access request in a message. View window 602c may be presented in response to a data object descriptor received in a communication without a text message. Rather than a UI element for displaying a text message, a remote attachments pane UI element 632c may be presented that identifies data objects located and/or otherwise identified by execution environment 401 of second node 504 that may be retrieved by execution environment 401 of first node 502. The data object descriptor may be received without a text message as FIG. 6C illustrates or may be received with a pre-written and/or automatically generated message. UI elements 634c-636c may be presented by execution environment 401 of first node 502 to allow the user of execution environment 401 of first node 502 to request the retrieval of one or more data objects, in whole or in part, identified in the data object descriptor.

An access request may be sent in a message supported by a communications agent 403, formatted in a manner analogous to that illustrated with respect to FIG. 8A. See U.S. patent application Ser. No. 12/833,014 (Docket No 0155) filed on Jul. 9, 2010, entitled “Methods, Systems, and Program Products for Processing a Request for a Resource in a Communication”. As described above, content manager component 409 in execution environment 401 of first node 502 may package the one or more data representations including a representation of an access request into a message in a communication. The message is formatted according to a communications protocol supported by communication agent 403 in execution environment 401 of first node 502. Communications protocol component 407 operating in execution environment 401 of first node 502 may send the message according to the specification(s) of the communications protocol. Content manager component 409 may alternatively or additionally encode and/or otherwise transform one or more of the data representations for sending in a data stream such as voice stream and/or a video stream for communicating in a communication.

Content manager component 409 operating in execution environment 401 included in and/or otherwise provided by first node 502 may provide the packaged, encoded, and/or transformed data to communications protocol component 407 via a com-out component 419. Com-out component 419 as described above operatively couples communications agent 409 to communications protocol component 407 according to an interface provided by communications protocol component 407 to send data in a communication according to a communications protocol. Communications protocol component 407 may further package and/or otherwise transform the data to send via network stack 405 for delivery via network 506 to execution environment 401 of second node 504.

Returning to FIG. 2A, a block 206 illustrates that the method yet further includes receiving, via the network by the first execution environment, at least a portion of the data object in response to sending the second message. Accordingly, a system for processing a reference in a communication to a remote data object includes means for receiving, via the network by the first execution environment, at least a portion of the data object in response to sending the second message. For example, the arrangement in FIG. 3A, includes data object handler component 306 that is operable for receiving, via the network by the first execution environment, at least a portion of the data object in response to sending the second message. FIG. 4 illustrate data object handler components 406 as an adaptations and/or analogs of data object handler component 306 in FIG. 3A. One or more data object handler components 406 operate in an execution environment 401. The system for processing a reference in a communication to a remote data object includes one or more processors and logic encoded in one or more tangible media for execution by the one or more processors that when executed is operable for receiving, via the network by the first execution environment, at least a portion of the data object in response to sending the second message. In FIG. 4, a data object handler component 406 is illustrated as a component of application 403.

FIG. 7 includes a dataflow that illustrates a third message 710 that includes some or all of a data object via network 506 by execution environment 401 of first node 502 from execution environment 401 of second node 504. The data object is received in respond to sending the access request in second message 708.

As described above, content manager component 409 operating in execution environment 401 of first node 502 may interoperate with communications protocol component 407 and/or network stack 405 to receive data in a communication, via network 506, with another communications agent in another node. Content manager component 409 is operatively coupled, via com-in component 411, to communications protocol component 407 to receive the data from the other node. Thus, execution environment 401 of first node 502 may receive a message in a communication with execution environment 401 of first node 504 via a com-in component 411. The message includes a data object or a portion thereof in response to sending an access request. Content director component 410 may be included in content manager component 409 to detect one or more portions of a received message, such as a portion that is a response to an access request. Content director component 410 may invoke one or more content handler components 413 to process one or more data objects provided in the message according to their type.

In one aspect, a data object returned in a message in response to sending an access request may be processed as an attachment and/or in a manner analogous to processing of an attachment for a particular communications type.

With reference to FIG. 2B, a block 212 illustrates that the method includes receiving, by a second communications agent that represents a second user, data object information that identifies a data object in a second data store in a second execution environment that includes the second communications agent. Accordingly, a system for processing a reference in a communication to a remote data object includes means for receiving, by a second communications agent that represents a second user, data object information that identifies a data object in a second data store in a second execution environment that includes the second communications agent. For example, the arrangement in FIG. 3B, includes data object handler component 306 that is operable for receiving, by a second communications agent that represents a second user, data object information that identifies a data object in a second data store in a second execution environment that includes the second communications agent. FIG. 4 illustrates data object handler component 406 as an adaptation and/or analog of data object handler component 306 in FIG. 3B. One or more data object handler components 406 operate in an execution environment 401. The system for processing a reference in a communication to a remote data object includes one or more processors and logic encoded in one or more tangible media for execution by the one or more processors that when executed is operable for receiving, by a second communications agent that represents a second user, data object information that identifies a data object in a second data store in a second execution environment that includes the second communications agent. In FIG. 4, a data object handler component 406 is illustrated as a component of communications agent 403.

FIG. 7 includes a dataflow that illustrates a locate message 712 for locating one or more data objects to identify in one or more data object descriptors. Locating a data object may include identifying a data object matching criterion. The matching criterion may be identified by input received from a user by execution environment 401 of second node 504. The one or more data objects may be located and/or otherwise identified by determining a data object or data objects that match the data object matching criterion. The data object(s) may be in a data store accessible to execution environment 401 of second node 504, such as one or more files in a file system 427 of execution environment 401 of second node 504. Locate message 712 may be internal to execution environment 401 of second node 504 and/or may include a message sent to a remote device, such as database server and/or a network attached storage device providing storage locations for some or all of file system 427 of execution environment 401 of second node 504.

FIG. 6D illustrates an edit window UI element 602d that, in an aspect, may be presented by communication agent 403 in execution environment 401 of second node 504 in response to a user input for creating a new message. Edit window UI element 602d includes an attachment search UI element 638d for receiving user input for specifying data object information that identifies a matching criterion for locating one or more data objects. A search UI element 640d is included for receiving a user input that authorizes and/or otherwise instructs execution environment 401 of second node 504 to locate data objects that match the matching criterion entered.

Attachment search UI element 638d and one or more UI elements it includes may be presented by one or more corresponding UI element handler component(s) 415 that may operate based on a schema that defines valid data object information for identifying a matching criterion. The schema defines one or more rules and/or a vocabulary that defines whether data object information is valid. Those skilled in the art will understand that numerous languages and/or schemas for providing data object information currently exist including relatively simple key word based queries, relatively more complicated regular expression languages, and data base query languages, such as various versions of structured query language (SQL). New schemas are and will be created, and are, thus, considered within the scope of the subject matter described herein.

Attachment search UI element 638d illustrates a user interface for a keyword based schema. Match textbox UI element 642d illustrates a textbox allowing a user to enter a keyword expression. Various checkbox UI elements 644d allow a user to define a scope for performing a locate operation by identifying whether a search based on a matching criterion is to be applied to folders, files, and/or content of files in a file system. A communications agent 403 may support more than one data object information schema. Thus, a communications agent may provide a user interface to receive valid data object information for one or more such schemas.

FIG. 6E, illustrates a search results UI element 646e that, in an aspect, may be presented by communication agent 403 in execution environment 401 of second node 504 in response to processing data object information received via detecting user input that corresponds to search UI element 640d in FIG. 6D. A user of communications agent 403 operating in execution environment 401 of second node 504 may provide input corresponding to search UI element 638d in edit window UI element 602d in FIG. 6D. A corresponding UI element handler component 415 may operate to invoke locate director component 412 to perform and/or otherwise to provide for performing one or more operations to locate one or more data objects based on the data object information. Locate director component 412 may interoperate with one or more UI element handlers 415, directly or indirectly via query handler component 429, in an aspect, to present search results UI element 646e and its contents. Search results UI element 646e includes results pane UI element 648e including representations of two data objects located and/or otherwise identified by locate director component 412 based on the data object information. User input may be detected in selecting one or more data objects to identify in a data object descriptor. An attach UI element 650e may be presented, as illustrated, to receive corresponding user input to instruct communications agent 403 to identify one or more selected data objects in results pane UI element 648e in a data object descriptor. An attach all UI element 652e is presented to receive corresponding user input to instruct communication agent 403 to identify all data objects represented and/or otherwise identified in search results UI element 646e in one or more data object descriptors. A cancel UI element 654e allows a corresponding detected user input to be processed end presentation of search results UI element 646e. A user may opt to identify no data objects represented and/or otherwise identified in the search results UI element 646e and located and/or otherwise identified by locate director component 412 based on data object information.

In another aspect, a locate director component 412 may request that a navigation window such as file system browser be presented to a user. The user may navigate a corresponding file system 427 to select and/or otherwise identify one or more data objects to be identified in data object information.

Returning to FIG. 2B, a block 214 illustrates that the method further includes creating a data object descriptor for accessing the data object from the second data store by a first execution environment including a first communications agent that represents a first user. Accordingly, a system for processing a reference in a communication to a remote data object includes means for creating a data object descriptor for accessing the data object from the second data store by a first execution environment including a first communications agent that represents a first user. For example, the arrangement in FIG. 3B, includes descriptor generator component 314 that is operable for creating a data object descriptor for accessing the data object from the second data store by a first execution environment including a first communications agent that represents a first user. FIG. 4 illustrates descriptor generator component 414 as an adaptation and/or analog of descriptor generator component 314 in FIG. 3B. One or more descriptor generator components 414 operate in an execution environment 401. The system for processing a reference in a communication to a remote data object includes one or more processors and logic encoded in one or more tangible media for execution by the one or more processors that when executed is operable for creating a data object descriptor for accessing the data object from the second data store by a first execution environment including a first communications agent that represents a first user. In FIG. 4, descriptor generator component 414 is illustrated as a component of communications agent 403.

FIG. 7 includes a dataflow that illustrates a create data object descriptor message 714 to processes results returned from locate message 712. In FIG. 4, create data object descriptor message 714 in FIG. 7 may represent data exchanged between locate director component 412 and descriptor generator component 414 to process results returned from a locate operation performed based on data object information. Processing the results may include creating and/or otherwise constructing a data object descriptor. Processing associated with create data object descriptor message 714 may be internal to execution environment 401 of second node 504 and/or may include interoperation by execution environment 401 of second node 504 via a network with another node.

Data objects located and/or otherwise identified by locate director component 412 may be identified to descriptor generator component 414 to construct and/or otherwise create a data object descriptor identifying the data objects. As described above, in an aspect, a user may be allowed to select which data objects, if any, are to be identified in a data object descriptor from one or more data objects located and/or otherwise identified by locate director component 412 based on received data object information.

FIG. 8B illustrates an exemplary data object descriptor described in detail above. Data object descriptor portion 804b illustrates the data object descriptor as a list of URIs identifying data objects in file system 427 of execution environment 401 of second node 504.

Returning to FIG. 2B, a block 216 illustrates that the method yet further includes sending, via a communications protocol via the network by the second communications agent, a first message, addressed to the first user, including the data object descriptor, wherein the data object is not included in the first message. Accordingly, a system for processing a reference in a communication to a remote data object includes means for sending, via a communications protocol via the network by the second communications agent, a first message, addressed to the first user, including the data object descriptor, wherein the data object is not included in the first message. For example, the arrangement in FIG. 3B, includes remote access handler component 316 that is operable for sending, via a communications protocol via the network by the second communications agent, a first message, addressed to the first user, including the data object descriptor, wherein the data object is not included in the first message. FIG. 4 illustrates remote access handler component 416 as an adaptation and/or analog of remote access handler component 316 in FIG. 3B. One or more remote access handler components 416 operate in an execution environment 401. The system for processing a reference in a communication to a remote data object includes one or more processors and logic encoded in one or more tangible media for execution by the one or more processors that when executed is operable for sending, via a communications protocol via the network by the second communications agent, a first message, addressed to the first user, including the data object descriptor, wherein the data object is not included in the first message. In FIG. 4, a remote access handler component 416 is illustrated as a component of application 403.

As described above, FIG. 7 includes first message 702 illustrating a message sent via network 506 to execution environment 401 of first node 502 from execution environment 401 of second node 504. First message 702 includes a data object descriptor.

Descriptor generator component 414 may provide the data object descriptor to content manager component 409 to include in a message, illustrated by first message 702. As described above, content manager component 409 may receive and/or otherwise identify various portions of a message, including a data object descriptor, from one or more content handler components 413. The data object descriptor may be provided to content manager component 409. As described above, content manager component 409 in execution environment 401 of second node 504 may package the one or more data representations including a representation of the data object descriptor into first message 702 formatted according to a suitable communications protocol. Communications protocol component 407 operating in execution environment 401 of second node 504 may send first message 702 in a communication with execution environment 401 of first node 502 according to the specification(s) of the communications protocol. Content manager component 409 may alternatively or additionally encode and/or otherwise transform one or more of the data representations for sending in a data stream such as voice stream and/or a video stream for communicating in the communication to the communications agent.

FIG. 8B includes a text message portion 802b illustrates a text message that may be included in first message 702. Note that a text message portion may be empty. Text message portion 802b and data object descriptor portion 804b may be provided by respective content handler components 413 to content manager component 409. Content manager component 409 may construct the content as illustrated in FIG. 8B and/or otherwise provide for encoding, translating, combining, and/or otherwise preparing the content for sending in the first message 702.

Returning to FIG. 2B, a block 218 illustrates that the method yet further includes receiving, via the first communications protocol via the network from the first communications agent, a second message addressed to the second user, that identifies, based on the data object descriptor, the data object. Accordingly, a system for processing a reference in a communication to a remote data object includes means for receiving, via the first communications protocol via the network from the first communications agent, a second message addressed to the second user, that identifies, based on the data object descriptor, the data object. For example, the arrangement in FIG. 3B, includes data object request component 318 that is operable for receiving, via the first communications protocol via the network from the first communications agent, a second message addressed to the second user, that identifies, based on the data object descriptor, the data object. FIG. 4 illustrates data object request component 418 as an adaptation and/or analog of data object request component 318 in FIG. 3B. One or more data object request components 418 operate in an execution environment 401. The system for processing a reference in a communication to a remote data object includes one or more processors and logic encoded in one or more tangible media for execution by the one or more processors that when executed is operable for receiving, via the first communications protocol via the network from the first communications agent, a second message addressed to the second user, that identifies, based on the data object descriptor, the data object. In FIG. 4, a data object request component 418 is illustrated as a component of application 403.

As described above, FIG. 7 includes a dataflow that illustrates a second message 708 that includes an access request to access a data object identified in the data object descriptor in first message 702. FIG. 7 illustrates the access request is received via network 506 from execution environment 401 of first node 502 by execution environment 401 of second node 504.

As described above, content manager component 409 operating in execution environment 401 of second node 504 may interoperate with communications protocol component 407 and/or network stack 405 to receive data in one or more messages via network 506 with another communications agent in another node. A data object (DO) request component 418 may receive some or all of the communication in receiving and/or otherwise identifying an access request in second message 708. Content manager component 409 in FIG. 4 operatively couples DO request component 418 with network 506, via com-in component 411, communications protocol component 407 and/or network stack 405 to receive the data from the other execution environment. Thus, execution environment 401 of second node 504 may receive a message, via content manager component 409 and DO request component 418, that includes an access request.

Com-in component 411 may provide data received in second message 708 to content manager component 409. Content handler component 409 may identify an access request in second message 708 sent from the execution environment 401 of first node 502. Content manager component 409 may interoperate with DO request component 418 in identifying the access request. The access request may be identified by content manager component 409 according to a schema for the communication protocol. For example, a portion of an email message may include a MIME-type identifier that identifies a corresponding part of the email as an access request and/or otherwise identifies the part for routing to DO request component 418 in communications agent 403 in execution environment 401 of second node 504 to detect the access request.

Data sent in second message 708, by execution environment 401 of first node 502, may be received by com-in component 411 operating in an instance, adaptation, and/or analog of execution environment 401 including and/or provided by second node 504. The received communication may include a user readable message addressed to the communicant represented by communications agent 403 in execution environment 401 of second node 504 and an access request identifying a data object in a data store of execution environment 401 of second node 504. Content manager component 409 may detect the text message. Content manager component 409 may detect the access request, which may be represented by a URI, in an aspect, in second message 708. The text message, if any, the access request portion may be provided to suitable content handler components 413 based on the content types of the text message portion and the access request portion detected by content manager component 409. In FIG. 4, the access request portion may be provided to DO request component 418 as a content handler that matches, for example, a MIME type field that identifies the access request portion.

Returning to FIG. 2B, a block 220 illustrates that the method yet further includes sending, via the network by the second execution environment, at least a portion of the data object in response to receiving the second message. Accordingly, a system for processing a reference in a communication to a remote data object includes means for sending, via the network by the second execution environment, at least a portion of the data object in response to receiving the second message. For example, the arrangement in FIG. 3B, includes data object response component 320 that is operable for sending, via the network by the second execution environment, at least a portion of the data object in response to receiving the second message. FIG. 4 illustrates data object response component 420 as an adaptation and/or analog of data object response component 320 in FIG. 3B. One or more data object response components 420 operate in an execution environment 401. The system for processing a reference in a communication to a remote data object includes one or more processors and logic encoded in one or more tangible media for execution by the one or more processors that when executed is operable for sending, via the network by the second execution environment, at least a portion of the data object in response to receiving the second message. In FIG. 4, a data object response component 420 is illustrated as a component of application 403.

FIG. 7 includes a dataflow that illustrates a get data object (DO) message 716 for locating one or more data objects identified in an access request. Locating a data object may include identifying a URI or other identifier of the data object in a data store. In another aspect, an access request may identify a matching criterion, such as a URI. The matching criterion may be based on a data object descriptor. In an aspect, the matching criterion may be based on user input. The one or more data objects may be retrieved and/or otherwise located by determining a data object or data objects that match the matching criterion. The data object(s) may be in a data store accessible to execution environment 401 of second node 504, such as one or more files in a file system 427 of execution environment 401 of second node 504. Get DO message 716 may be internal to execution environment 401 of second node 504 and/or may include a message sent to a remote device, such as database server and/or a network attached storage device providing storage locations for some or all of file system 427 of execution environment 401 of second node 504.

In an aspect, communications agent 403 in FIG. 4 may invoke locate director component 412 automatically to locate one or more data objects based on an access request, in response to detecting the access request in a message. In another aspect, communications agent 403 may invoke locate director component 412 automatically to locate one or more data objects based on an access request in a message in response to detecting an indication to present, via an output device, some or all of a text message received in the message in the communication. Locate director component 412 may be invoked and/or may operate based on the access request and/or data object matching criterion identified to locate a data object prior to, during, and/or after other content received in the message is processed.

In another aspect, locating a data object may include presenting a locator UI element representing and/or otherwise identifying an access request. A data store navigation and/or search user interface may be presented as described above for receiving one or inputs from a user to locate one or more data objects identified in the access request.

In another aspect, an access request UI element may be presented to receive one or more additional matching criteria from a user. Based on the access request UI element and input from the user, locate director component 412 may receive one or more additional data object matching criteria and/or may receive input to modify a data object matching criterion identified in a received access request. Locate director component 412 may locate one or more data objects in response to receiving the additional criterion.

FIG. 7 includes a dataflow that illustrates an include data object message 718 to processes results returned from get DO message 716. Include data object message 718, in FIG. 7, may represent, in FIG. 4, data exchanged between locate director component 412 and data object response component 420 to process results returned from a locate operation performed based on an access request. Processing the results may include creating and/or otherwise constructing one or more attachments that include the one or more data objects identified in the results. Processing associated with include data object message 718 may be internal to execution environment 401 of second node 504 and/or may include interoperation by execution environment 401 of second node 504 via a network with another node.

Data objects located and/or otherwise identified by locate director component 412 may be identified to DO response component 420 to construct and/or otherwise create one or more attachments including one or more identified data objects. As described above, in an aspect, a user may be allowed to select which data objects, if any, are to be attached to a response message from one or more data objects located and/or otherwise identified by locate director component 412 based on a received access request

As described above, FIG. 7 includes a data flow illustrating third message 710 illustrating a message sent via network 506 to execution environment 401 of first node 502 from execution environment 401 of second node 504. Third message 702 includes an attachment including a data object or portion thereof requested in an access request in second message 708.

DO response component 420 may provide the attachment to content manager component 409 to include in a message, illustrated by third message 710. As described above, content manager component 409 may receive and/or otherwise identify various portions of a message, including an attachment, from one or more content handler components 413. The attachment may be provided to content manager component 409. As described above, content manager component 409 in execution environment 401 of second node 504 may package the one or more data representations including a representation of the attachment into third message 710 formatted according to a suitable communications protocol. Communications protocol component 407 operating in execution environment 401 of second node 504 may send third message 710 in a communication with execution environment 401 of first node 502 according to the specification(s) of the communications protocol. Content manager component 409 may alternatively or additionally encode and/or otherwise transform one or more of the data representations for sending in a data stream such as voice stream and/or a video stream for communicating in the communication to the communications agent.

The methods illustrated in FIG. 2A-B may include additional aspects supported by various adaptations and/or analogs of the arrangement of components in FIG. 3A-B. In various aspects, a data object identification request may be based on a date, a time, a length of time, a file type, a database record key, content of the data object, a content type identifier, a format rule, a vocabulary, a role of a user, a security attribute, a location in a data store such as a file system, an attribute of an identified data object, a size, a task, a transaction, a state, a user, a group, a requester, a relationship including a requesting user and a responding user, a keyword, a tag, a folder, and/or a path portion of a data object identifier—to name a few examples.

With reference to FIG. 2A, the method may further include receiving, by the first communication agent in the first execution environment, data object information, identifying a data object matching criterion, from a first user represented by the first communications agent. Accordingly, a system for processing a data object identification request in a communication includes means for receiving, by the first communication agent in the first execution environment, data object information, identifying a data object matching criterion, from a first user represented by the first communications agent. For example, the arrangement in FIG. 4, may include query handler component 429 that is operable for receiving, by the first communication agent in the first execution environment, data object information, identifying a data object matching criterion, from the first user represented by the first communications agent. One or more query handler components 429 may operate in an execution environment 401. The system for processing a data object identification request in a communication includes one or more processors and may include logic encoded in one or more tangible media for execution by the one or more processors that when executed is operable for receiving, by the first communication agent in the first execution environment, data object information, identifying a data object matching criterion, from the first user represented by the first communications agent. In FIG. 4, query handler component 429 is illustrated as a component of communications agent 403.

FIG. 7 includes a dataflow that illustrates a data object (DO) information message 720 that may be processed internal to execution environment 401 of first node 502 and/or a may include processing a message received via network 506 by execution environment 401 of first node 502. DO information message 720 illustrates a data object information dataflow to query handler component 429 operating in execution environment 401 of first node 502. Data object information is identified to and/or otherwise received by query handler component 429.

In various aspects, a query handler component 429 may receive data object information from a user via one or more UI element handler components 415. The data object information may be received, in response to a user input detected by an input device of an execution environment 401 that includes the query handler component 429. Alternatively or additionally, data object information may be received by a query handler component in a message received via a network. For example, a user may identify data object information to a browser operating in a client node. The browser may send the data object information via a network communicatively coupling the client node to a web service provider node. The web service provider node may include a query handler component that may operate to receive the data object information identified in the message from the browser.

FIG. 6F illustrates an exemplary user interface that may be presented by communications agent 403 operating in execution environment 401 of first node 502. A UI element handler component 415 may operate to present a user interface element to allow a user to identify data object information. A data object information (DOI) UI element 656f is illustrated in FIG. 6F as an example. The same or different UI element handler component 415 may present various other UI elements included in DOI UI element 656f. DOI UI element 656f and one or more UI elements it includes may be presented by one or more corresponding UI element handler component(s) 415 that may operate based on a schema that defines valid data object information and/or data object identification requests for including in a message by a communications agent 403. The schema defines one or more rules and/or a vocabulary that defines whether data object information and/or a data object identification request is valid. Those skilled in the art will understand that numerous languages and/or schemas for providing data object information and/or data object identification requests.

DOI UI element 656f illustrates a user interface for a keyword based schema. Match textbox UI element 658f illustrates a textbox allowing a user to enter a keyword expression. Various checkbox UI elements 660f allow a user to define a scope of a data object identification request by identifying whether a resulting data object identification request is to be applied to folders, files, and/or content of files in a file system. A communications agent 403 may support more than one data object identification request schema and/or corresponding data object information schema. Thus, a communications agent may provide a user interface to receive valid data object information for each respective schema.

Returning to FIG. 2A, the method may still further include sending, according to the first communications protocol via the network in a communication to the second communications agent in the second execution environment representing the second user, a previous message including a data object identification request based on the data object matching criterion, wherein the previous message is addressed to the second user. Accordingly, a system for processing a data object identification request in a communication includes means for sending, according to the first communications protocol via the network in a communication to the second communications agent in the second execution environment representing the second user, a previous message including a data object identification request based on the data object matching criterion, wherein the previous message is addressed to the second user. For example, the arrangement in FIG. 4 may include identification request constructor (IRC) component 431 that is operable for sending, according to the first communications protocol via the network in a communication to the second communications agent in the second execution environment representing the second user, a previous message including a data object identification request based on the data object matching criterion, wherein the previous message is addressed to the second user. One or more identification request constructor components 404 may operate in an execution environment 401. The system for processing a data object identification request in a communication includes one or more processors and may include logic encoded in one or more tangible media for execution by the one or more processors that when executed is operable for sending, according to the first communications protocol via the network in a communication to the second communications agent in the second execution environment representing the second user, a previous message including a data object identification request based on the data object matching criterion, wherein the previous message is addressed to the second user. In FIG. 4, identification request constructor component 431 is illustrated as a component of communications agent 403.

FIG. 7 includes a dataflow that illustrates a construct identification (CI) request message 722 that may be processed internal to execution environment 401 of first node 502 and/or may include processing a message received via network 506 by execution environment 401 of first node 502. CI request message 722 illustrates processing to provide and/or otherwise identify data object information to an IRC component 431 operating in execution environment 401 of first node 502. A query handler component 429 may identify and/or otherwise provide data object information to an IRC component 431.

A query handler component may be a type of content handler component that operates to process data object information to create a data object identification request that conforms to a schema for creating and/or otherwise constructing a valid data object identification request. IRC component 431 may construct and/or otherwise create a data object identification request based on a schema that defines and/or otherwise identifies a valid data object identification request and/or a valid data object descriptor for a particular type of message supported by a communications agent. The data object identification request is constructed and/or otherwise created, based on the data object information, by IRC component 431. IRC component 431 in execution environment 401 of first node 502 may provide the data object identification request to content manager component 409 to include and/or otherwise identify the data object identification request in a message to execution environment 401 of second node 504, such as an email and/or an instant message. Content manager component 409 may interoperate with other types of content handler components 413 to create and/or otherwise construct a message that includes the valid data object identification request.

In an aspect, IRC component 431 may interoperate with content manager component 409 to create the valid data object identification request according to a specified schema for the message, so that the message is valid according to a communications protocol supported by a communications protocol component 407 that operates to send the message. As described above, content manager component 409 may operate in execution environment 401 of first node 502 along with an IRC component 431 to transform data object information into a data object identification request to include along with data for other parts of a message into one or more representations suitable for transmitting in a communication, such as a message, to another node, such as execution environment 401 of second node 504. Some or all of the representations transmitted are suitable for processing by the communications agent in execution environment 401 of second node 504. The content manager component 409 in the execution environment 401 of first node 502 may package the one or more data representations including a representation of the data object identification request into a message formatted according to the communications protocol.

In FIG. 8A, a portion of an email communication 800a is illustrated formatted as a multipart/mixed content type including data object identification request portion 802a. A data object identification request portion of a communication may be identified as a data object identification request by its location in the communication and/or by an identifier or markup element, such as a MIME type identifier. A data object identification request may be detected based on content included in the message and/or based on metadata such as content-type header 804 identifying a MIME type identifier, such as “application/id-request”, which may be defined for representing one or more matching criteria in a data object identification request. The “application/id-request” MIME type identifier is exemplary. Other MIME type identifiers exist and/or may be defined to identify a data object identification request in a communication.

An IRC 431 and/or a content manager component 409 may operate to construct a data object identification request in a message based on XQuery, regular expression, and/or SQL content—to name a few examples. A content type identifier may be included in a position and/or location that identifies a data object identification request in a communication. The position or location may be absolute or relative. For example, a schema for a communication may define that a data object identification request in a communication is included in the communication at the end of the communication. There may be one or more data object identification requests at the end. In another aspect, a schema for a communication may specify that a portion of a communication following a particular type of message portion is a data object identification request. Other data object identification requests may follow. If no data object identification request is included, the data object identification request portion may include no content or may include an indicator that no data object identification request is included.

FIG. 8A illustrates an “application/id-request” MIME type identifier that may be defined to identify a schema for an XML-based language for specifying id-request XML documents. FIG. 8A illustrates id-request document 806a. Id-request document 806a, as illustrated, includes criterion tag elements 808a corresponding to the form elements in a user interface FIG. 6F. A criterion tag element 808a identifies a data object matching criterion name, such as “query” indicating that the criterion is a query expression or a portion thereof. A “type” attribute identifies a schema with the identifier “keyword” for the expression. The criterion tag element 808a identifies a value for a query “Uncle Joe” in a match-expression attribute. Another criterion tag element 808a specifies a scope query specified in the first criterion tag element. FIG. 8A illustrates an “and” tag 810a indicating that all the matching criteria must be met for identifying a data object. An “or” tag (not shown) may be defined by a schema for id-request documents. Other operator elements and operator precedence may be defined by the schema. Grouping elements for managing operator precedence, such as parenthesis element, may be defined by the schema.

FIG. 7 includes a dataflow that illustrates a previous message 724, including a data object identification request, sent via network 506 by execution environment 401 of first node 502 to execution environment 401 of second node 504.

A data object identification request generated by an IRC component 431, along with a text message and any other data to include in previous message 724, may be provided and/or otherwise identified to content manager component 409 for sending in previous message 724. The content manager component 409 in execution environment 401 of first node 502 may package the one or more data including a representation of the data object identification request into previous message 724 formatted according to the communications protocol. Com-out component 419 may provide the data object identification request, the text message, and any other data for sending in previous message 724 in representations suitable for sending by communications protocol component 407 to the communications agent in execution environment 401 of second node 504. Communications protocol component 407 operating in execution environment 401 of first node 502 may send the data in previous message 724, such as an email message, according to the specification(s) of the communications protocol. Communications protocol component 407 may further package and/or otherwise transform the data to send via network stack 405 for delivery via network 506 to execution environment 401 of second node 504.

Content manager component 409 may alternatively or additionally encode and/or otherwise transform one or more of the data representations for sending in a data stream such as voice stream and/or a video stream for communicating in a communication with the communications agent in execution environment 401 of second node 504.

With reference to FIG. 2B, the method may further include receiving, via the network by the second communication agent representing the second user and operating in the second execution environment, the previous message from the first communication agent representing a first user and operating in the first execution environment. Accordingly, a system for processing a data object identification request in a communication may include means for receiving, via the network by the second communication agent representing the second user and operating in the second execution environment, the previous message from the first communication agent representing a first user and operating in the first execution environment. For example, the arrangement in FIG. 4 may include content manager component 409 that is operable for receiving, via the network by the second communication agent representing the second user and operating in the second execution environment, the previous message from the first communication agent representing a first user and operating in the first execution environment. One or more content manager components 409 may operate in an execution environment 401. The system for processing a data object identification request in a communication includes one or more processors and may include logic encoded in one or more tangible media for execution by the one or more processors that when executed is operable for receiving, via the network by the second communication agent representing the second user and operating in the second execution environment, the previous message from the first communication agent representing a first user and operating in the first execution environment. In FIG. 4, a content manager component 409 is illustrated as a component of communications agent 403.

FIG. 7, as described above, illustrates previous message 724, including a data object identification request, received via network 506 by execution environment 401 of second node 504 from execution environment 401 of first node 502.

A content manager component 409 may operate to detect a data object identification request received and/or otherwise identified in a message received in a communication. Content manager component 409 operating in execution environment 401 of second node 504 may receive the message, illustrated by previous message 724, in a communication with execution environment 401 of first node 502. Com-in component 411 in execution environment 401 of second node 504 may receive previous message 724 via communication protocol component 407 and network stack 405. Previous message 724 may be delivered to execution environment 401 of second node 504 via network 506 based on a communications address of a communicant represented by communications agent 403 in execution environment 401 of second node 504. A communications agent may represent more than one communicant identified by different addresses.

Previous message 724 in FIG. 7 may be received in one or more packets via network 506 by network stack 405 and communications protocol component 407 in an instance of and/or analog of execution environment 401 including and/or otherwise provided by execution environment 401 of second node 504. The data in previous message 724 may be received by com-in component 411. Com-in component 411 may provide the data to content manager component 409. Content manager component 409 may determine one or more content types of the data. The content and/or portions of the content may be provided to one or more content type handler components 413 based on the one or more content types identified by content manager component 409. For example, FIG. 8A illustrates text message portion 812a including “text/plain” MIME type identifier 814a as a content type identifier. Text message portion 812a may be provided to a text/plain content handler 413. Audio data in a voice communication may be provided to an audio content handler component 413, and video data in a video communication may be provided to a video content handler component 413.

With respect to the method illustrated in FIG. 2B, the method may further include detecting, by the second communication agent, the data object identification request included in the previous message. Accordingly, a system for processing a data object identification request in a communication may include means for detecting, by the second communication agent, the data object identification request included in the previous message. For example, the arrangement in FIG. 4 may query handler component 429 that is operable for detecting, by the second communication agent, the data object identification request included in the previous message. One or more query handler components 429 may operate in an execution environment 401. The system for processing a data object identification request in a communication includes one or more processors and may include logic encoded in one or more tangible media for execution by the one or more processors that when executed is operable for detecting, by the second communication agent, the data object identification request included in the previous message. In FIG. 4, query handler component 429 is illustrated as a component of communications agent 403.

FIG. 7 includes a dataflow that illustrates a detect identification (DI) request message 726 that may be processed internal to execution environment 401 of second node 504 and/or may include interoperation with another node via a network. With respect to FIG. 4, DI request message 726 may correspond to a data exchange and/or other interoperation between content handler component 409 and query handler component 429 to detect and/or otherwise process the data object identification request received in previous message 724 by execution environment 401 of first node 504. FIG. 7 further illustrates locate message 712, described above. In as aspect, locate message 712 may be processed in response to DI request message 726. The data object identification request may include and/or otherwise identify a data object matching criterion identified by data object information identified by the communicant represented by execution environment 401 of first node 502. The one or more data object may be located and/or otherwise identified by determining a data object or data objects that match the data object matching criterion.

Com-in component 411 in execution environment 401 of second node 504, as described above, may provide previous message 724, received from execution environment 401 of first node 502, to content manager component 409. Content manager component 409 is operatively coupled, via com-in component 411, to communications protocol component 407 for receiving data in communications with other nodes, such as execution environment 401 of first node 502. Thus, execution environment 401 of second node 504 may receive previous message 724 via a com-in component 411 in a communication with execution environment 401 of first node 502. Previous message 724 may include a data object identification request that identifies data object information identified based on user input detected by communications agent 403 in execution environment 401 of first node 502.

Content manager component 409 may detect and/or otherwise identify a portion of previous message 724 as the data object identification request sent from execution environment 401 of first node 502. The data object identification request may be identified by content manager component 409 according to a schema for the message and/or a schema for the data object identification request. For example, a portion of the message may include a MIME-type identifier that identifies the portion as a data object identification request and/or otherwise identifies the portion for routing to a query handler component 429 operating in and/or otherwise on behalf of execution environment 401 of second node 504. Alternatively or additionally, the data object identification request may have structure and/or content that is valid and identifiable according to a schema for defining and/or otherwise identifying valid data object identification requests. A query handler component may be provided as a type of content handler component, in an aspect. Alternatively or additionally, a query handler component may interoperate with one or more content handler components to detect a data object identification request in a message received by a content manager component.

As such, query handler component 429 may operate along with other content handler components 413 to process data representations received in previous message 724 from execution environment 401 of first node 502. Query handler component 429 may also provide transformed data from the representations to one or more user interface element handler components 415. Query handler component 429 operates to validate and process data object identification requests according to a schema defining valid data object identification requests. Various portions of a message including a data object identification request may be provided to one or more content handler components 413, including query handler component 429, to interoperate with presentation controller component 417 in execution environment 401 of second node 504 to present some or all of the received message, including the data object identification request. Examples of such user interfaces are described above with respect to at least FIG. 6D and FIG. 6E.

As described herein in an aspect, content manager component 409 may detect content type information to detect a data object identification request in a communication. For example, the text message portion illustrated in FIG. 8A may be received in previous message 724. Content manager component 409 may detect “application/id-request” MIME type identifier in content-type header 804a. The “application/id-request” MIME type identifier may be defined to identify a data object identification request based on one or more matching criteria for identifying a requested data object. Content manager component 409 may identify data object identification request portion 802a as including the data object identification request.

In response to detecting a data object identification request in previous message 724, content manager component 409 may provide some or all of the data object identification request to query handler component 429. For example, query handler component 429 may be configured to operate according to a schema defining a format and/or a vocabulary for an XML-based language for id-request documents. Content manager component 409 may provide id-request document 806a, as a data object identification request, to query handler component 429. Query handler component 429 may operate according to the id-request schema. In an aspect, a query handler component may process more than one data object identification request content type. Alternatively or additionally, execution environment 401 may include multiple query handler components 429 for supporting multiple data object identification request content types.

In another aspect, a data object located and/or otherwise identified in response to receiving a data object identification request must meet match a query identified by the data object identification request. Alternatively or additionally, a data object identification request may include an instruction and/or input for generating a data object, and locating the data object may include generating the data object. Generating a data object may include creating the data object and/or may include modifying and/or otherwise transforming an existing data object. For example, execution environment 401 of second node 504 may include a template stored in a file system. A data object identification request may identify the template. A query handler component 429 may operate to identify a document or other data object that may be created, is being created, and/or has been created based on the template. In response to an access request, execution environment 401 of second node 504 may return the document.

As described above, in various aspects, a data object identification request may be detected and/or represented based on various syntaxes, grammars, vocabularies, and/or languages. For example, a data object identification request may be identified and/or represented according to a file system search syntax, a regular expression language, a structured query language (SQL) query, a universal data object identifier schema, an XPATH based language, an XQuery based language, an XML based language, an HTML based language (form-based), and/or a keyword-value pair based language.

A data object identification request in a communication may be communicated via a network according to a first communications protocol. A text message may be exchanged between communicants in the communication via a second communications protocol. For example, a data object identification request may be sent on behalf of a first communicant by execution environment 401 of first node 502 including a communications agent 403 representing the first communicant. The data object identification request may be included in a communication along with a text message sent to the execution environment 401 of second node 504. The communicants represented by the execution environment 401 of first node 502 and the execution environment 401 of second node 504 may communicate via one or more exchanges of audio exchanged via a voice over IP (VoIP) communications protocol.

Exemplary data objects that may be requested via a data object identification request include a file, a program component, a data base record, video data, audio data, markup language, binary data, text data, an output of a service. Requested data objects may be pre-existing, volatile, and/or generated in response to the request.

As described above, receiving data object information may include receiving a message, identifying the data object information, via network from a node that received the data object information from the user. For example, data object information may be received from a browser by a web server.

Data object information and/or a data object identification request may be generated, detected, and/or otherwise processed according to a schema that identifies at least one of a rule and a vocabulary that defines a valid data object identification request. Similarly, a data object descriptor, an access request, and an access response to an access request may be generated, detected, and/or otherwise processed according to a schema. One or more schemas may alone or together define one or more of valid data object information, a data object identification request, data object descriptor, an access request, and/or a data object or a portion thereof. A schema, as just describe, may be identified based on a data received and/or otherwise identified by a node hosting a communications agent via the network from another node hosting communications agent and/or from a path node included in a network path in the network communicatively coupling the node to one or more nodes that respectively host a communications agent.

In a further aspect, multiple alternative schemas may be defined for each of data object information, data object identification requests, data object descriptors, access requests, and/or a data object or a portion thereof processing data object identification requests. A schema may be selected and/or otherwise identified from the multiple schemas based by environment 401 of first node 502 and the execution environment 401 of second node 504 and/or based on information exchanged by the two nodes. For example, a schema may be selected by the first communicant and/or the second communicant. One may inform the other, via a communications protocol and/or via any other suitable means. The communicants may negotiate which schema to use via any suitable means.

The communications agents in execution environment 401 of second node 504 and execution environment 401 of first node 502 may select a schema For example, a schema may be identified and/or otherwise selected based on a communications protocol supported and/or a communications protocol not supported by one or both nodes. That is, in negotiating which communication protocol to use allowing communicants to exchange information, a schema may be identified. A schema may be identified and/or otherwise selected based on an attribute of the data object. A schema for identifying image data may be different from a schema for editable text documents. A schema for identifying a data object in a first file system may be different from a schema for identifying a data object in a different file system.

As described above. In an aspect, data object information and/or a data object identification request may identify a scope that specifies all or some portion of one or more data stores for locating a data object. For example, a communication agent 403 in execution environment 401 of first node 502 may receive user input that identifies a folder in a file system of the execution environment 401 of second node 504 that defines a scope for locating a data object.

Data object information and/or a data object identification request may be represented and/or otherwise identified in a representation that includes a complete or a portion of at least one of a keyword expression, a regular expression, an XQuery expression, an XPath expression, a file system path expression, and a structured query language statement.

Further as also described above, a data object identification request, a data object descriptor, an access request, and/or a data object or a portion thereof may be included in a message according to a schema that identifies the message as valid for a specified communications protocol. Those skilled in the art are aware that schemas for email differ from schemas for instant messages and from streamed audio, for example. A data object identification request, a data object descriptor, an access request, and/or a data object or a portion thereof may be exchanged in a communication in which audio data and/or image data is also exchanged. Multimedia may be a packaged to include one or more data streams that may include text based data streams.

A data object identification request, a data object descriptor, an access request, and/or a data object or a portion thereof may be included in an email, an instant message, a multi-media message, a short-message service message, and/or a data stream. The data stream may include audio data, image data, and/or text data.

A data object identification request, a data object descriptor, an access request, an/or a data object or a portion thereof may be included in and/or detected in a communication based on a location in the communication and/or based on a marker, such as an identifier in the communication that identifies a location for the data object identification request, the data object descriptor, the access request, and/or the data object or a portion thereof. The location may be absolute, such as fixed number of bytes or fields from the start or end of a message. Alternatively or additionally, the location may be identified by a location relative to another detectable portion of the communication. FIGS. 8A-B illustrate the user of MIME type identifiers as markers that identify locations for one or more of a data object identification request, a data object descriptor, an access request, an/or a data object or a portion thereof in a communication.

A data object identification request, a data object descriptor, an access request, an/or a data object or a portion thereof or respective portions thereof may include at least a portion of a keyword expression, a regular expression, expression including a Boolean operator, an expression including a precedence information, and a structured query language statement.

With respect to the method illustrated in FIG. 2B, the method as described above may include locating and/or otherwise identifying a data object automatically in response to receiving an access request that matches and/or otherwise identifies the data object. Further, a data object descriptor may be created and/or otherwise generated automatically, in response to locating and/or otherwise identifying the data object.

In an aspect, in response to receiving and/or otherwise detecting a data object identification request, a user interface may be presented based on the data object identification request to prompt a user to process the data object identification request in some manner, such as authorizing the request and/or modify the request by restricting its scope. In response to detecting user input targeting and/or otherwise corresponding to the presented user interface, one or more data objects may be located and/or otherwise identified based on the data object identification request. A user may change a received data object identification request. One or more data objects may be located and/or otherwise identified based on the changed data object identification request.

In a further aspect, once one or more data objects are located and/or otherwise identified based on a data object identification request, a user interface may be presented to allow a user to identify the one or more data objects. User information may be received that selects one or more data objects to identify in a data object descriptor and/or to not identify in the data object descriptor. A user, in an aspect, may be allowed to identify a data object not located and/or otherwise identified by the user's node. The data object, based on the user input, is identified in the data object descriptor.

In light of the description provided above, a data object descriptor may be generated automatically in response to detecting a corresponding data object identification request by an execution environment 401 of first node 502. Further, the automatically generated data object descriptor, may be sent to the node that sent the corresponding data object identification request, automatically in response to the generating of the data object descriptor.

With respect to the method illustrated in FIG. 2A, the second message may be sent automatically in response to detecting the data object descriptor. In another aspect, a representation of a received data object descriptor may be presented, via an output device, to a user. The representation may identify one or more data objects located and/or otherwise identified based on the data object identification request. The representation may be presented automatically, in response to detecting the data object descriptor. Further, a user input may be detected that corresponds to and/or otherwise targets the representation. The user input may be processed as an indication to retrieve the data object. As a result, an access request may be created or otherwise generated, that identifies the data object. The access request may be sent in a message via the network to retrieve the data object. The message may be sent to a node that sent the data object descriptor and/or to another node. The second message may be sent by the communication agent in the execution environment 401 of first node 502 to the communications agent in the execution environment 401 of second node 504 via a communications protocol. The second message, sent via the communication protocol, may include a communications address, in an address space of the communications protocol, which identifies a user represented by the communications agent in the execution environment 401 of second node 504. The second message may include a data object identification request, a data object descriptor, and/or a data object sent in response to previously receiving a data object or a portion thereof by the execution environment 401 of first node 502. The second message may include an access request that identifies the data object. The access request may include a universal data object identifier (URI) that identifies the data object.

With respect to the method illustrated in FIG. 2B, in response to receiving an access request, a data object identified in the request may be sent. The data object may be sent automatically, in response to receiving the access request. The data object may be sent as attachment in a communication. The data object may be sent by a communications agent in the execution environment 401 of second node 504 to a communications agent in the execution environment 401 of first node 502 via a communications protocol. The data object may be sent via a communication that includes a communications address, in an address space of the communications protocol, which identifies the first communicant represented by the execution environment 401 of first node 502. The communication that includes the data object may include a data object identification request, a data object descriptor, and/or an access request sent in response to a data object descriptor sent previously by the first node.

The methods illustrated in FIG. 2A-B may yet further include additional aspects supported by various adaptations and/or analogs of the arrangement of components in FIG. 3A-B. Performing the method illustrated in FIG. 2A and/or the method illustrated in FIG. 2B and/or any of its extension and/or in any of its aspects may include one or more of calling a function or method of an object, sending a message via a network; sending a message via an inter-process communication mechanism such as a pipe, a semaphore, a shared data area, and/or a queue; and/or receiving a request such as poll and responding to invoke, and sending an asynchronous message.

Output devices suitable for presenting a representation of a data object and/or a tag include a visual output device, an audio output device, and a tactile output device. One output device may present a data object and another output device may present a tag with which the data object is tagged.

Any action included in performing the method illustrated in FIG. 2A as well as any action included in performing the method illustrated in FIG. 2B may include sending and/or receiving a message via a network. Further, a message, included in performing any of the subject matter described herein and/or any of its extensions in any of its aspects, may an asynchronous message without a corresponding request.

To the accomplishment of the foregoing and related ends, the descriptions and annexed drawings set forth certain illustrative aspects and implementations of the disclosure. These are indicative of but a few of the various ways in which one or more aspects of the disclosure may be employed. The other aspects, advantages, and novel features of the disclosure will become apparent from the detailed description included herein when considered in conjunction with the annexed drawings.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components may be added while still achieving the functionality described herein. Thus, the subject matter described herein may be embodied in many different variations, and all such variations are contemplated to be within the scope of what is claimed.

To facilitate an understanding of the subject matter described above, many aspects are described in terms of sequences of actions that may be performed by elements of a computer system. For example, it will be recognized that the various actions may be performed by specialized circuits or circuitry (e.g., discrete logic gates interconnected to perform a specialized function), by program instructions being executed by one or more processors, or by a combination of both. The description herein of any sequence of actions is not intended to imply that the specific order described for performing that sequence must be followed.

Moreover, the methods described herein may be embodied in executable instructions stored in a tangible computer readable medium for use by or in connection with an instruction execution machine, system, apparatus, or device, such as a computer-based or processor-containing machine, system, apparatus, or device. As used here, a “tangible computer readable medium” may include one or more of any suitable media for storing the executable instructions of a computer program in one or more forms including an electronic, magnetic, optical, and electromagnetic form, such that the instruction execution machine, system, apparatus, or device may read (or fetch) the instructions from the tangible computer readable medium and execute the instructions for carrying out the described methods. A non-transitory computer readable storage medium is tangible. A non-exhaustive list of conventional exemplary tangible computer readable storage media includes a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), and a Blu-Ray™ disc; and the like.

Thus, the subject matter described herein may be embodied in many different forms, and all such forms are contemplated to be within the scope of what is claimed. It will be understood that various details may be changed without departing from the scope of the claimed subject matter. Furthermore, the foregoing description is for the purpose of illustration only, and not for the purpose of limitation, as the scope of protection sought is defined by the claims as set forth hereinafter together with any equivalents.

All methods described herein may be performed in any order unless otherwise indicated herein explicitly or by context. The use of the terms “a” and “an” and “the” and similar referents in the context of the foregoing description and in the context of the following claims are to be construed to include the singular and the plural, unless otherwise indicated herein explicitly or clearly contradicted by context. The foregoing description is not to be interpreted as indicating that any non-claimed element is essential to the practice of the subject matter as claimed.

1. A method for processing a reference in a communication to a remote data object, the method comprising:
receiving, via a first communications protocol via a network from a second execution environment, a first message, by a first communications agent in a first execution environment, that includes a data object descriptor that identifies a data object in a data store in the second execution environment, wherein the first message is addressed to a first user represented by the first communication agent;
sending, via the first communications protocol via the network by the first communications agent, a second message addressed to a second user represented by a second communications agent in the second execution environment, that identifies, based on the data object descriptor, the data object; and
receiving, via the network by the first execution environment, at least a portion of the data object in response to sending the second message,
wherein performing at least one of the preceding actions comprising the method includes execution of an instruction by a processor.

2. The method of claim 1 wherein the at least one of data object descriptor identifies a scope specifying at least a portion of the second data store and the data object descriptor includes information for the second execution environment for at least one of generating and modifying the data object.

3. The method of claim 1 receiving the first message includes detecting the data object descriptor in the first message along with a user readable text message from the second user.

4. The method of claim 1 wherein at least one of the first message and the second message are included an exchange between the first execution environment and the second execution environment of at least one of audio data and video data via at least one of the first communications protocol and a second communications protocol.

5. The method of claim 1 wherein the at least one of the first message and the second message at least one of includes and is included in at least one of an email, an instant message, a multi-media message, a short-message service message, a data stream

6. The method of claim 1 wherein the data object is received by the first execution environment in a third message and the data object is included in the third message as an attachment.

7. A method for processing a reference in a communication to a remote data object, the method comprising:
receiving, by a second communications agent that represents a second user, data object information that identifies a data object in a second data store in a second execution environment that includes the second communications agent;
creating a data object descriptor for accessing the data object from the second data store by a first execution environment including a first communications agent that represents a first user;
sending, via a communications protocol via the network by the second communications agent, a first message, addressed to the first user, including the data object descriptor, wherein the data object is not included in the first message;
receiving, via the first communications protocol via the network from the first communications agent, a second message addressed to the second user, that identifies, based on the data object descriptor, the data object; and
sending, via the network by the second execution environment, at least a portion of the data object in response to receiving the second message,
wherein performing at least one of the preceding actions comprising the method includes execution of an instruction by a processor.

8. The method of claim 7 wherein the data object descriptor identifies a scope specifying at least a portion of the second data store.

9. The method of claim 7 wherein the data object descriptor includes information for the second execution environment for at least one of generating and modifying the data object.

10. The method of claim 7 sending the first message includes sending the data object descriptor in the first message separate from a user readable text message included in the first message.

11. The method of claim 7 wherein receiving the second message includes detecting, in the second message, an access request identifying the data object.

12. The method of claim 12 wherein the access request is included in the second message along with a user text message from the first user.

13. The method of claim 7 wherein receiving the second message includes presenting, via an output device, a representation of the access request, that identifies the data object to the second user.

14. The method of claim 7 wherein at least one of the first message and the second message is sent in a communication that includes an exchange between the first execution environment and the second execution environment of at least one of audio data and video data.

15. The method of claim 7 wherein at least one of the first message and the second message at least one includes and is included in at least one of includes or is included in at least one of an email, an instant message, a multi-media message, a short-message service message, and a data stream

16. The method of claim 7 wherein the at least a portion of the data object is sent by the second execution environment in a third message, via the first communications protocol. and the data object is included in the third message as an attachment.

17. A tangible computer readable medium embodying a computer program, executable by a machine, for processing a reference in a communication to a remote data object, the computer program comprising executable instructions for:
receiving, via a first communications protocol via a network from a second execution environment, a first message, by a first communications agent in a first execution environment, that includes a data object descriptor that identifies a data object in a data store in the second execution environment, wherein the first message is addressed to a first user represented by the first communication agent;
sending, via the first communications protocol via the network by the first communications agent, a second message addressed to a second user represented by a second communications agent in the second execution environment, that identifies, based on the data object descriptor, the data object; and
receiving, via the network by the first execution environment, at least a portion of the data object in response to sending the second message.

18. A tangible computer readable storage embodying a computer program, executable by a machine, for processing a reference in a communication to a remote data object, the computer program comprising executable instructions for:
receiving, by a second communications agent that represents a second user, data object information that identifies a data object in a second data store in a second execution environment that includes the second communications agent;
creating a data object descriptor for accessing the data object from the second data store by a first execution environment including a first communications agent that represents a first user;
sending, via a communications protocol via the network by the second communications agent, a first message, addressed to the first user, including the data object descriptor, wherein the data object is not included in the first message;
receiving, via the first communications protocol via the network from the first communications agent, a second message addressed to the second user, that identifies, based on the data object descriptor, the data object; and
sending, via the network by the second execution environment, at least a portion of the data object in response to receiving the second message.
